(19) United States
(12) Patent Application Publication
(10) Pub. No.: US 2019/0118232 A1
(43) Pub. Date: Apr. 25, 2019

(54) ARTICLES FOR MANIPULATING IMPINGING LIQUIDS AND ASSOCIATED METHODS

(71) Applicant: Massachusetts Institute of Technology, Cambridge, MA (US)

(72) Inventors: Rajeev Dhiman, Glastonbury, CT (US); James C. Bird, Cambridge, MA (US); Hyukmin Kwon, Cambridge, MA (US); Kripa K. Varanasi, Lexington, MA (US)

(73) Assignee: Massachusetts Institute of Technology, Cambridge, MA (US)

(21) Appl. No.: 15/980,060

(22) Filed: May 15, 2018

Related U.S. Application Data
(63) Continuation of application No. 15/037,648, filed on May 18, 2016, now abandoned.
(60) Provisional application No. 61/905,834, filed on Nov. 18, 2013.

(51) Int. Cl. B08B 17/06; B05D 5/08

(52) U.S. Cl. CPC B08B 17/065; B05D 2202/00; Y02B 10/30; B05D 5/083

(57) ABSTRACT

Presented herein are articles and methods relating to manufactured superhydrophobic, superoleophobic, and/or supermetallophobic surfaces with macro-scale features (macro features) configured to induce controlled asymmetry in a liquid film produced by impinging phase (e.g., impinging droplet(s)) onto the surface, thereby further reducing the contact time between an impinging liquid and the surface.

### CROSS-REFERENCE TO RELATED APPLICATION

This application claims priority to and the benefit of, and incorporates herein by reference in its entirety U.S. Provisional Patent Application No. 61/905,834, which was filed on Nov. 18, 2013.

### FIELD OF THE INVENTION

This invention relates generally to manufactured surfaces that manipulate impinging liquids. More particularly, in certain embodiments, the invention relates to manufactured superhydrophobic, superoleophobic, and/or supermetallophobic surfaces with macro-scale features (macro features) that further reduce the contact time between an impinging liquid (e.g., droplets) and the surface. The macro features facilitate asymmetric recoil of a higher proportion of impinging liquid (e.g., droplets) from the surface per unit area of the surface.

### BACKGROUND OF THE INVENTION

Superhydrophobicity, a property of a surface when it resists contact with water, has been a topic of intense research during the last decade due to its potential in a wide variety of applications, such as self-cleaning, liquid-solid drag reduction, water repellency and resistance to icing. Superhydrophobic surfaces have demonstrated an ability to stay dry, self-clean, and resist icing, because impinging drops avoid adhering to the surfaces and instead bounce off. Water repellency of superhydrophobic surfaces is often studied by droplet impingement experiments in which millimetric drops of water are impacted onto these surfaces and photographed. When liquid drops impact non-wetting surfaces, the drops spread out to a maximum diameter then recoil such that they rebound off the solid material. The amount of time the drop is in contact with the solid—the contact time—can also depend on the inertia and capillarity of the drop, as well as internal dissipation and surface-liquid interactions. With appropriate surface design, droplets can be made to bounce off the surface completely. However, the time taken to bounce off—hereafter referred to as the contact time—is critically important as mass, momentum, and/or energetic interactions take place between the droplet and the surface during the time of contact.

Minimizing the contact time of a droplet with a contacting surface has a number of significant advantages. For example, the energy required to deice an airplane wing can be reduced if a water drop rebounds off the wing before it freezes. Ice build-up can be prevented if freezing rain bounces off a cold surface faster than the contact area solidifies. Both processes of solidifying and bouncing off can occur on the order of milliseconds.

Recent literature suggests that there is a theoretical minimum contact time, t_{c}. See M. Reyssat, D. Richard, C. Clanet, and D. Quere, Faraday Discuss., 2010, 146, pp. 19-33; and D. Quere, Nature Letters, 2002, 417, pp. 811. Specifically, models that estimate the effects of contact line pinning on contact time have found that the contact time scales as

$${t}_{c} \approx 2.2 {( \frac{ρ {R}^{3}}{γ} )}^{1 / 2} ( 1 + \frac{φ}{4} ) \qquad ( 1 )$$

where t_{c} is the contact time of a drop, of radius R, density ρ, and surface tension γ, bouncing on a superhydrophobic surface with pinning fraction ϕ. Even if one were able to completely eliminate this surface pinning such that ϕ=0, there would still be a minimum contact time limited by the drop hydrodynamics.

New articles, devices, and methods are needed to decrease the contact time between a droplet and a surface for improved liquid repellency. Contact times less than the theoretical minimum have heretofore been believed to be impossible.

### SUMMARY OF THE INVENTION

The articles, devices, and methods presented herein incorporate unique surface designs that can manipulate the morphology of an impinging droplet and lead to a significant reduction (e.g., more than 50% below the theoretical minimum prediction of Equation 1) in the time of contact between a droplet and its target surface. These designs are capable of improving the performance of a wide variety of products that are negatively affected by droplet impingement. Examples of such products include, but are not limited to, rainproof consumer products (e.g., rainproof articles (e.g., articles that are impermeable to rain), waterproof articles (e.g., articles that are impermeable to water), e.g., clothing articles, protective gear, umbrellas, etc.), steam turbine blades, wind turbine blades, aircraft wings, engine blades, gas turbine blades, atomizers, and condensers.

To minimize contact time of a droplet impinging a surface, the conventional wisdom has been to minimize surface-liquid interactions, since these can lead to pinning. It has been postulated that there is a minimum contact time that cannot be reduced further, even in the absence of surface interactions, due to the droplet hydrodynamics.

Counterintuitively, it is found presently that manufactured surfaces described herein can enhance, rather than attenuate, the influence of surface interactions, and can actually decrease the observed contact time below the theoretical limit. Without wishing to be bound by any particular theory, it is believed the morphology of the surface assists in redistributing the liquid mass upon impact, altering the drop hydrodynamics, and reducing the overall contact time below the previously achieved minimums.

The passive surfaces (e.g., which exhibit desired properties without application of mechanical force during use of these surfaces) described herein, which reduce contact time of impinging droplets thereupon, have broad industrial applications. For example, the surfaces (e.g., manufactured or retrofitted) can be used for improvement of the performance of nano-air vehicles in precipitation to increasing the overall efficiency of steam turbines. In addition to water, the surfaces may also be implemented (e.g., manufactured or retrofitted) to repel complex fluids such as blood, crude oil, polymer solutions, emulsified drops, synovial fluid, non-Newtonian fluids, ionic fluids, and the like. They may be surfaces of, for example, fabrics, sportswear, tents, camping gear, industrial equipment, automobiles, other vehicles, building materials, roofing, drones, flying robots, etc.

In some embodiments, the surfaces of the articles discussed herein include one or more types of macro features. In some embodiments, the presence of the one or more types of macro features facilitates asymmetric recoil of a higher proportion of the impinging phase (e.g., droplets, liquids, fluids) from the surface per unit area of the surface. In some embodiments, the presence of the macro features further reduces the time of impact between the impinging phase (e.g., droplets) and the underlying surface. In some embodiments, the presence of the one or more types of macro features facilitates centre-assisted recoil of the impinging phase from the surface, resulting in a decreased contact time with the impinging phase (e.g., and thus improving rainproof, anti-fouling, anti-scaling, etc. properties of the surface). In some embodiments, the presence of the one or more types of macro features helps assure that a larger proportion of the impinging phase (e.g., droplets) comes into contact with the one or more types of macro features. Thus, in some embodiments, a larger percentage of the impinging phase (e.g., droplets) undergoes centre-assisted retraction from the surface.

In some embodiments, when an droplet impinges on a surface that includes macro features, the droplet assumes the shape of the macro feature on which it impinges, as will be discussed in further detail below and in the accompanying drawings. In some embodiments, the macro feature includes a number of ridges that intersect at a common point thereby forming one or more angles between the ridges. In some embodiments, the ridges intersect such that the angle between all the ridges is the same. In some embodiments, the ridges intersect such that the ridges form at least two different angles between the ridges. In some embodiments, at least one of the one or more angles between the intersecting ridges is an acute angle (i.e., an angle less than 90°). In some embodiments, at least one of the one or more angles between the intersecting ridges is a right angle (i.e., 90°). In some embodiments, at least one of the one or more angles between the intersecting ridges is an obtuse angle (i.e., greater than 90° but less than) 180°.

In some embodiments, when a droplet impinges on a surface that includes macro features, the droplet assumes the shape of the macro feature on which it impinges, as will be discussed in further detail below and in the accompanying drawings. In some embodiments, the macro feature includes a number of ridges that intersect at a common point thereby forming one or more angles between the ridges. In some embodiments, the ridges intersect such that the angle between all the ridges is the same. In some embodiments, the ridges intersect such that the ridges form at least two different angles between pairs of adjacent ridges. In some embodiments, at least one of the one or more angles formed by the intersecting ridges is an acute angle (i.e., an angle less than 90°). In some embodiments, at least one of the one or more angles formed by the intersecting ridges is a right angle (i.e., 90°). In some embodiments, at least one of the one or more angles formed by the intersecting ridges is an obtuse angle (i.e., greater than 90° but less than 180°).

In some embodiments, the macro features include two or more ridges that do not intersect. In some embodiments, the two or more ridges that do not intersect are nonparallel, i.e., two of the ridges are positioned such that, if extended to intersection, would form a non-180° angle. In some embodiments, the extended, non-intersecting ridges form at least one of an acute angle (i.e., an angle less than 90°), a right angle (i.e., 90°), an obtuse angle (i.e., greater than 90° but less than 180°), or a reflex angle (i.e., an angle greater than 180°).

In some embodiments, the macro features include two or more ridges that meet at a central point (e.g., spoke shape, e.g., where two or more ridges radiate from a central point). In some embodiments, the two or more ridges form one or more angles between each other. In some embodiments, the angles formed by adjacent ridges are substantially identical. In some embodiments, the ridges form two or more distinct angles. In some embodiments, at least one of the one or more angles between the ridges is an acute angle (i.e., an angle less than 90°). In some embodiments, at least one of the one or more angles between the ridges is a right angle (i.e., 90°). In some embodiments, at least one of the one or more angles between the ridges is an obtuse angle (i.e., greater than 90° but less than 180°).

Per EPA recommendation, industrial fluorocarbons used in industry is shifting from C8 chemistry to C6 chemistry. While this shift is safer for the environment and health, there is reduced water-repellency observed for surfaces having C6 chemistry. In certain embodiments, the surfaces presented herein can be used to deliver surfaces that have droplet repellency equivalent to C8 chemistry surfaces, while using safer C6 chemistry. In some embodiments, the surface includes eco-friendly C6-type fluoropolymer or a combination of several eco-friendly C6-type fluoropolymers. In some embodiments, the fluoropolymer is a C6 analog of poly(perfluorodecylacrylate) (PFDA).

Furthermore, in certain embodiments, the manufactured surface comprises rare-earth ceramics, for example, as a conformal coating, or the surface itself (e.g., on which the droplets impinge) is made of a rare-earth ceramic. In some embodiments, the rare-earth ceramic includes one or more types of macro features described herein. In some embodiments, the rare earth ceramic is a hydrophobic rare earth ceramic. In some embodiments, the rare earth ceramic comprises a rare earth material (e.g., rare earth oxide, e.g., ceria, erbia).

This application incorporates herein by reference in its entirety U.S. Provisional Patent Application No. 61/514,794, which was filed on Aug. 3, 2011 and International Application No. PCT/US2011/061498, filed on Nov. 18, 2011.

The articles, devices, and methods described herein offer several advantages over previous approaches in the field of water repellency using superhydrophobic surfaces. For example, the articles, devices, and methods lead to a major reduction (e.g., over 50%) in the contact time compared to the existing best reported contact time in the literature (i.e., the minimum contact time predicted by Equation 1, above). This surprising reduction in contact time is desirable not only to control diffusion of mass, momentum, or energy (depending upon the application), but also to prevent droplets from getting stuck on a surface due to impact from neighboring impinging droplets. In addition, the approach described herein is more practical and scalable as it relies on introducing macro-scale features that are easy to machine or fabricate with current tools. By contrast, previous approaches focus on the use of micron to sub-micron features that are difficult to fabricate and, at best, provide contact times that approach but do not fall below the minimum predicted by Equation 1. Contact times achieved using the articles, devices, and methods described herein are lower than those attainable with the lotus leaf (the best known superhydrophobic surface), which is limited by Equation 1.

The articles, devices, and methods described herein may be used in a wide variety of industries and applications where droplet repellency is desirable. For example, textile companies that manufacture rainproof fabrics, such as rainwear, umbrellas, automobile covers, etc., could significantly improve fabric waterproof performance. Likewise, energy companies that manufacture steam turbines could reduce moisture-induced efficiency losses caused by water droplets entrained in steam, which impinge on turbine blades and form films, thereby reducing power output. Condensers in power and desalination plants may utilize the devices and methods described herein to promote dropwise shedding condensation heat transfer. Further, in aircraft and wind turbine applications, a reduced contact time of supercooled water droplets impinging upon aircraft surfaces is desirable to prevent the droplets from freezing and thereby degrading aerodynamical performance. In atomizer applications, the ability of surfaces to break up droplets can be used to create new atomizers for applications in engines, agriculture, and pharmaceutical industries. In gas turbine compressors, the devices and methods described herein may be used to prevent oil-film formation and reduce fouling.

In one aspect, the invention is directed to a manufactured (or retrofitted) article comprising a surface that is one or more of the following: (a) a superhydrophobic surface (e.g., a surface having a static contact angle with water of at least 120° and a contact angle hysteresis with water of less than 30°, irrespective of the presence of macro features described herein), (b) a superoleophobic surface (e.g., a surface having a contact angle with liquid oil (e.g., an alkane (e.g., decane, hexadecane, octane), silicone oils, fluorocarbons, and the like) of at least 120° and a contact angle hysteresis with the liquid oil of less than 30°), and/or (c) a supermetallophobic surface (e.g., a surface having a static contact angle with liquid metal (e.g., liquid tin, and the like) of at least 120° and a contact angle hysteresis with the liquid metal of less than 30°), wherein said surface comprises one or more types of macro features, said one or more types of macro features comprising one or more members selected from the following: (i) spaced-apart discrete groups of ridges (projections), wherein each group of ridges comprises a plurality of ridges (linear and/or non-linear), said ridges being angled with respect to each other and/or said ridges intersecting each other and/or two or more of said ridges terminating at a common point; (ii) spaced-apart discrete groups of grooves (depressions), wherein each group of grooves comprises a plurality of grooves (linear and/or non-linear), said grooves being angled with respect to each other and/or said grooves intersecting each other and/or two or more of said grooves terminating at a common point; (iii) a pattern of intersecting ridges (linear and/or non-linear), wherein said pattern comprises spaced-apart intersections of ridges; (iv) a pattern of intersecting grooves (linear and/or non-linear), wherein said pattern comprises spaced-apart intersections of grooves; (v) a pattern of ridges and grooves that intersect with each other (ridges intersecting with ridges, grooves intersecting with grooves, and/or ridges intersecting with grooves); (vi) spaced-apart discrete groups of features, each of said groups comprising one or more ridges and one or more grooves; (vii) a plurality of spaced-apart hybrid ridge-groove features, each of said ridge-groove features comprising a ridge having a groove running along its length, said groove laying between the two edges of the ridge; and (viii) a plurality of spaced-apart hybrid groove-ridge features, each of said groove-ridge features comprising a groove having a ridge running along its length, said ridge laying between the two edges of the groove.

In certain embodiments, the macro features (e.g., ridges and/or grooves) have a height or depth of from about 10 micrometers to about 500 micrometers, and a height of from about 20 micrometers to about 1000 micrometers. In certain embodiments, the macro features are spaced from about 0.1 millimeter to about 10 millimeters apart. In certain embodiments, the surface has a submicron roughness. In certain embodiments, the article is a fabric, a solar panel, a building component, a vehicle, and/or industrial equipment. In some embodiments, the building component is or comprises roof tile.

In some embodiments, the surface is superhydrophobic and has a static contact angle with water of at least 120° and a contact angle hysteresis with water of less than 30°, irrespective of the presence of macro features.

In some embodiments, the surface is superoleophobic and has a contact angle with liquid oil of at least 120° and a contact angle hysteresis with the liquid oil of less than 30°. In some embodiment, the liquid oil is or comprises an alkane. In some embodiments, the liquid oil is or comprises a silicone oil. In some embodiments, the liquid oil is or comprises a fluorocarbon.

In some embodiments, the surface is supermetallophobic and has a static contact angle with liquid metal of at least 120° and a contact angle hysteresis with the liquid metal of less than 30°. In some embodiments, the liquid metal is liquid tin.

In some embodiments, droplet(s) and/or liquid impinges on the surface of the article. In some embodiments, the droplet and/or liquid recoils from the surface of the article asymmetrically following contact with the surface. In some embodiments, the droplet and/or liquid contacts the surface for a time period less than theoretical minimum contact time t_{c}:

$$2.2 {( \frac{ρ {R}^{3}}{γ} )}^{1 / 2} ( 1 + \frac{φ}{4} ) ,$$

where t_{c} is the contact time of a drop, of radius R, density ρ, and surface tension γ, bouncing on the surface with pinning fraction ϕ, wherein the impinging droplet recoils from the surface asymmetrically after contacting the surface.

In some embodiments, the contact time is less than 50% of the theoretical minimum contact time t_{c}.

In some embodiments, the surface includes a C6 fluoropolymer. In some embodiments, the C6-type fluoropolymer is or includes poly(2-(Perfluoro-3-methylbutyl)ethyl methacrylate). In some embodiments, the C6 fluoropolymer is selected from the group consisting of 3,3,4,4,5,5,6,6,7,7,8,8,8-tridecafluorooctyl methacrylate; 1H, 1H, 2H, 2H-perfluorooctyl acrylate; 2-(perfluorohexyl) ethyl methacrylate; [N-methyl-perfluorohexane-1-sulfonamide]ethyl acrylate; [N-methyl-perfluorohexane-1-sulfonamide]ethyl (meth) acrylate; 2-(Perfluoro-3-methylbutyl)ethyl methacrylate; 2-[[[[2-(perfluorohexyl) ethyl]sulfonyl]methyl]-amino]ethyl]acrylate; and any combination or copolymers thereof

In some embodiments, the article includes a rare earth material. In some embodiments, the rare earth material is or comprises a rare earth oxide. In some embodiments, the rare earth material includes at least one member selected from the group consisting of scandium (Sc), yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), and lutetium (Lu).

In some embodiments, the article includes impinging droplet(s) or liquid, wherein the one or members (i)-(viii) facilitate asymmetric recoil of a higher proportion of the impinging droplet(s) or liquid from the surface per unit area of the surface.

In some embodiments, the one or more types of macro features include (v) the pattern of ridges and grooves that intersect with each other, comprising at least one pattern selected from the group consisting of ridges intersecting with ridges, grooves intersecting with grooves, and/or ridges intersecting with grooves.

In another aspect, the invention is directed to a method of preventing or reducing fouling and/or icing (droplet freezing on the surface) by employing the article of any one of the embodiments described above (e.g., exposing the article to impinging droplets) (e.g., for solar panel packaging), e.g., thereby promoting passive removal of foulant from the surface and/or thereby inhibiting freezing of droplets on the surface.

In some embodiments, the method includes exposing the article to impinging droplet(s) or liquid, wherein the article promotes removal of the impinging droplet(s) or liquid from the surface. In some embodiments, the method also includes exposing the article to a foulant, wherein the article promotes removal of the foulant from the surface without application of mechanical force.

In another aspect, the invention is directed to a method of reducing or eliminating charge transfer from droplets to a surface (e.g., thereby reducing corrosion caused by transport of charge via droplets) by employing the article of any one of the embodiments described above (e.g., exposing the article to impinging droplets that carry charge).

In another aspect, the invention is directed to a method of enhancing water repellency by employing the article of any one of the embodiments described above (e.g., exposing the article to impinging water droplets).

In certain embodiments, ridge surfaces (or grooves) are impregnated with a lubricant to improve low hysteresis characteristics. The impregnating liquid can be, for example, a liquid, a semi-solid, a ferrofluid, a magneto-rheological fluid, an electro-rheological fluid, or an emulsion.

In some embodiments, the surface includes a fluoropolymer. In some embodiments, the fluoropolymer is a C6 analog of PFDA. In some embodiments, the fluoropolymer comprises poly(2-(Perfluoro-3-methylbutyl)ethyl methacrylate), or any copolymer comprising 2-(Perfluoro-3-methylbutyl)ethyl methacrylate. In some embodiments, the fluoropolymer is crosslinked.

In one aspect, the invention relates to an article including a non-wetting surface having a dynamic contact angle of at least about 90°, said surface patterned with macro-scale features configured to induce controlled asymmetry in a liquid film produced by impingement of a droplet onto the surface, thereby reducing time of contact between the droplet and the surface. In certain embodiments, the non-wetting surface is superhydrophobic, superoleophobic, and/or supermetallophobic. In one embodiment, the surface includes a non-wetting material. The surface may be heated above its Leidenfrost temperature.

In certain embodiments, the surface includes non-wetting features, such as nanoscale pores. In certain embodiments, the macro-scale features include ridges having height Aᵣ and spacing λᵣ, with Aᵣ/h greater than about 0.01 and λᵣ/Aᵣ greater than or equal to about 1, wherein h is lamella thickness upon droplet impingement onto the surface. In certain embodiments, Aᵣ/h is from about 0.01 to about 100 and λᵣ/Aᵣ is greater than or equal to about 1. In one embodiment, Aᵣ/h is from about 0.1 to about 10 and λᵣ/Aᵣ is greater than or equal to about 1.

In certain embodiments, the article is a wind turbine blade, the macro-scale features include ridges having height Aᵣ and spacing λᵣ, and wherein 0.0001 mm<Aᵣ and λᵣ≥0.0001 mm. In certain embodiments, the article is a rainproof product, 0.0001 mm<Aᵣ and λᵣ≥0.0001 mm. In some embodiments, the article is a steam turbine blade, 0.00001 mm<Aᵣ and λᵣ>0.0001 mm. In one embodiment, the article is an exterior aircraft part, 0.00001 mm<Aᵣ and λᵣ>0.0001 mm. The article may be a gas turbine blade with 0.00001 mm<Aᵣ and λᵣ>0.0001 mm.

In certain embodiments, the macro-scale features include protrusions having height Aₚ and whose centres are separated by a distance λₚ, with Aₚ/h>0.01 and λₚ/Aₚ≥2, wherein h is lamella thickness upon droplet impingement onto the surface. In certain embodiments, 100>Aₚ/h>0.01 and λₚ/Aₚ≥2. In one embodiment, 10>Aₚ/h>0.1 and λₚ/Aₚ≥2. The macro-scale features may be hemispherical protrusions.

In certain embodiments, the article is a wind turbine blade, the macro-scale features include protrusions having height Aₚ and whose centres are separated by a distance λₚ, and wherein 0.0001 mm<Aₚ and λₚ≥0.0002 mm. In certain embodiments, the article is a rainproof product, 0.0001 mm<Aₚ and λₚ≥0.0002 mm. In various embodiments, the article is a steam turbine blade, 0.00001 mm<Aₚ and λₚ≥0.00002 mm. In certain embodiments, the article is an exterior aircraft part, 0.00001 mm<Aₚ and λₚ≥0.00002 mm. The article may be a gas turbine blade with 0.00001 mm<Aₚ and λₚ≥0.00002 mm.

In certain embodiments, the macro-scale features include a sinusoidal profile having amplitude A_{c} and period λ_{c}, with A_{c}/h>0.01 and λ_{c}/A_{c}≥2, wherein h is lamella thickness upon droplet impingement onto the surface. In certain embodiments, 100>A_{c}/h>0.01 and 500≥λ_{c}/A_{c}≥2. In various embodiments, 100>A_{c}/h>0.1 and 500≥λ_{c}/A_{c}≥2. As used herein, “sinusoidal” encompasses any curved shape with an amplitude and period.

In certain embodiments, the article is a rainproof product, the macro-scale features include a sinusoidal profile having amplitude A_{c} and period λ_{c}, and wherein 0.0001 mm<A_{c} and λ_{c}≥0.0002 mm. In one embodiment, the article is a wind turbine blade, 0.0001 mm<A_{c} and λ_{c}≥0.0002 mm. The article may be a steam turbine blade with 0.00001 mm<A_{c} and λ_{c}≥0.00002 mm. The article may be an exterior aircraft part with 0.00001 mm<A_{c} and λ_{c}≥0.00002 mm. In certain embodiments, the article is a gas turbine blade, 0.00001 mm<A_{c} and λ_{c}≥0.00002 mm.

In certain embodiments, the surface includes an alkane. In one embodiment, the surface includes a fluoropolymer. In certain embodiments, the surface includes at least one member selected from the group consisting of Teflon (polytetrafluoroethylene), trichloro(1H,1H,2H,2H-perfluorooctyl)silane (TCS), octadecyltrichlorosilane (OTS), heptadecafluoro-1,1,2,2-tetrahydrodecyltrichlorosilane, fluoroPOSS, a ceramic material, a polymeric material, a fluorinated material, an intermetallic compound, and a composite material. In certain embodiments, the surface includes a polymeric material, the polymeric material including at least one of polytetrafluoroethylene, fluoroacrylate, fluorourethane, fluorosilicone, fluorosilane, modified carbonate, chlorosilanes, and silicone. In certain embodiments, the surface includes a ceramic material, the ceramic material including at least one of titanium carbide, titanium nitride, chromium nitride, boron nitride, chromium carbide, molybdenum carbide, titanium carbonitride, electroless nickel, zirconium nitride, fluorinated silicon dioxide, titanium dioxide, tantalum oxide, tantalum nitride, diamond-like carbon, and fluorinated diamond-like carbon. In certain embodiments, the surface includes an intermetallic compound, the intermetallic compound including at least one of nickel aluminide and titanium aluminide. In certain embodiments, the article is a condenser. The article may be a drip shield for storage of radioactive material. In certain embodiments, the article is a self-cleaning solar panel.

In another aspect, the invention relates to an atomizer including a non-wetting surface having a dynamic contact angle of at least about 90°, said surface patterned with macro-scale features configured to induce controlled asymmetry in a liquid film produced by impingement of a droplet onto the surface, thereby promoting breakup of the droplet on the surface. The description of elements of the embodiments above can be applied to this aspect of the invention as well. In certain embodiments, the non-wetting surface is supermetallophobic. In certain embodiments, the droplet includes a molten metal.

Elements of embodiments described with respect to a given aspect of the invention may be used in various embodiments of another aspect of the invention. For example, it is contemplated that features of dependent claims depending from one independent claim can be used in apparatus and/or methods of any of the other independent claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

While the invention is particularly shown and described herein with reference to specific examples and specific embodiments, it should be understood by those skilled in the art that various changes in form and detail may be made therein without departing from the spirit and scope of the invention.

FIG. 1a is a schematic side view of a droplet resting on a surface during a static contact angle measurement, according to an illustrative embodiment of the invention.

FIGS. 1b and 1c are schematic side views of a liquid spreading and receding, respectively, on a surface, according to an illustrative embodiment of the invention.

FIG. 1d is a schematic side view of a droplet resting on an angled surface, according to an illustrative embodiment of the invention.

FIGS. 1e and 1f depict typical side and top views, respectively, of a water droplet (2.7 mm in diameter) impinging a superhydrophobic surface, according to an illustrative embodiment of the invention.

FIGS. 2a and 2b are high-speed images of a drop bouncing on a superhydrophobic silicon surface made of silicon, textured by laser-ablation. The images show that the drop detaches from the surface after 12.4 ms (drop radius R=1.33 mm; impact velocity=1.2 ms⁻¹). Inset, electron microscopy reveals the microscopic structure of the surface. FIG. 2b includes simultaneous top view images of the drop shown in FIG. 2a. FIG. 2b illustrates that the drop is nearly axisymmetric throughout the impact with the superhydrophobic silicon surface.

FIG. 2c is a schematic diagram of typical axisymmetric recoil with uniform retraction along the rim.

FIG. 2d is a diagram portraying an arbitrary non-axisymmetric retraction in which the centre of the film formed by an impinging droplet assists in the recoil of the impinging droplet, according to an illustrative embodiment of the invention.

FIG. 2e shows experimental evidence, according to an illustrative embodiment of the invention, that a recoil shown in the diagram of FIG. 2d is possible when macrotexture (indicated by red arrows) is incorporated into the superhydrophobic surface made of silicon, textured by laser-ablation. The drop centre actively assists in the retraction of the droplet. The size of the impinging droplet was the same as for the droplets shown in FIGS. 2a and 2b.

FIG. 2f shows a photograph of a droplet recoiling asymmetrically from a superhydrophobic surface, according to an illustrative embodiment of the invention.

FIG. 3a is a schematic top view of a droplet undergoing symmetric recoil, similar to that shown in FIG. 2b, after impingement, according to an illustrative embodiment of the invention.

FIG. 3b is a schematic top view of a droplet undergoing asymmetric recoil due to nucleation of holes, according to an illustrative embodiment of the invention.

FIG. 3c is a schematic top view of a droplet undergoing asymmetric recoil due to development of cracks, according to an illustrative embodiment of the invention.

FIG. 3d is a schematic side view of a droplet that has spread onto a curved surface (and assumed the shape of the curved surface) to form a lamella, according to an illustrative embodiment of the invention.

FIG. 4 is a schematic side view and a detailed view of a surface for triggering cracks in a receding liquid film, according to an illustrative embodiment of the invention.

FIG. 5a includes schematic top and cross-sectional views of a droplet recoiling on a flat surface axisymmetrically, according to an illustrative embodiment of the invention.

FIG. 5b includes schematic top and cross-sectional views of a droplet recoiling on a ridge, where the droplet recoils asymmetrically, according to an illustrative embodiment of the invention.

FIG. 5c includes SEM images of a fabricated silicon surface with both submicrometre roughness and structure on a macroscopic (˜100 μm) scale manufactured by laser ablation, according to an illustrative embodiment of the invention.

FIGS. 5d and 5e show simultaneous high-speed images captured when a drop impacts a silicon surface with the macroscopic structure revealing that the overall contact time is reduced by 37% to 7.8 ms (from the 12.4 ms time observed in FIG. 2a), according to an illustrative embodiment of the invention. FIGS. 5d and 5e show that when a drop impacts the surface with the macroscopic texture, it moves rapidly along the ridge as it recoils.

FIG. 5f illustrates schematic top and cross-sectional views of a droplet recoiling on a ridge, according to an illustrative embodiment of the invention. FIG. 5f illustrates the formation of cracks around the ridge.

FIGS. 6a-6c include top, cross-sectional, and high-magnification scanning electron microscope (SEM) images of a macro-scale ridge (height˜150 μm, width˜200 μm) fabricated on a silicon wafer using laser-rastering, according to an illustrative embodiment of the invention.

FIG. 6d includes high-speed photography images of droplet impingement on the ridge of FIGS. 6a-6c, according to an illustrative embodiment of the invention.

FIG. 7a is an SEM image of a macro-scale ridge (height˜100 μm, width˜200 μm) milled on an anodized aluminum oxide (AAO) surface, according to an illustrative embodiment of the invention.

FIG. 7b is a high-magnification SEM image of the AAO surface of FIG. 7a, showing nanoscale pores, according to an illustrative embodiment of the invention.

FIG. 7c includes high-speed photography images of droplet impingement on the ridge of FIG. 7a, according to an illustrative embodiment of the invention.

FIG. 8 is a schematic perspective view of macro-scale protrusions on a surface, according to an illustrative embodiment of the invention.

FIG. 9a is an SEM image of macro-scale protrusions (˜50-100 μm) fabricated on anodized titanium oxide (ATO) surface, according to an illustrative embodiment of the invention.

FIG. 9b is a high-magnification SEM image of the ATO surface of FIG. 9a showing nanoscale features, according to an illustrative embodiment of the invention.

FIG. 9c includes high-speed photography images of droplet impingement on the surface of FIG. 9a, according to an illustrative embodiment of the invention.

FIG. 10 includes a schematic cross-sectional view and a detailed schematic cross-sectional view of a surface having a macro-scale sinusoidal profile to trigger curvature in a receding liquid film, according to an illustrative embodiment of the invention.

FIG. 11a includes a photograph showing a macro-scale sinusoidal surface fabricated on silicon and an image showing high magnification SEM sub-micron features, according to an illustrative embodiment of the invention.

FIG. 11b includes high-speed photography images of droplet impingement on the surface of FIG. 11a, according to an illustrative embodiment of the invention.

FIG. 12a is a schematic view of droplet impingement on a solid surface at the instant of impact, according to an illustrative embodiment of the invention.

FIG. 12b is a schematic view of droplet impingement on a solid surface during spreading, according to an illustrative embodiment of the invention.

FIG. 12c is a schematic view of droplet impingement on a solid surface at the instant when spreading comes to a rest, according to an illustrative embodiment of the invention.

FIG. 13a is an example of a stand-alone macro feature made of intersecting ridges, according to an illustrative embodiment of the invention.

FIG. 13b is a photograph of a single droplet recoiling off a surface textured with parallel micro ridges after impacting the micro ridges, according to an illustrative embodiment of the invention. The droplet bounces off the micro ridge. The micro ridges have a height and width of on the order of 100 μm. The surface on which the droplet impinges is aluminum heated above its Leidenfrost temperature. The observed contact time was lower than the theoretical minimum provided by Equation 1 above.

FIGS. 13c-13e are photographs of a droplet impinging and recoiling off an aluminum surface heated above its Leidenfrost temperature, where the surface includes a central point and three ridges (spokes) radiating from the central point, according to an illustrative embodiment of the invention.

FIGS. 13f-13h are photographs of a droplet impinging and recoiling off an aluminum surface heated above its Leidenfrost temperature, where the surface includes two intersecting ridges (spokes), according to an illustrative embodiment of the invention.

FIGS. 13i-13k are photographs of a droplet impinging and recoiling off an aluminum surface heated above its Leidenfrost temperature, where the surface includes a central point and five ridges (spokes) radiating from the central point, according to an illustrative embodiment of the invention.

FIGS. 13l-13n are photographs of a droplet impinging and recoiling off an aluminum surface heated above its Leidenfrost temperature, where the surface includes a central point and six ridges (spokes) radiating from the central point, according to an illustrative embodiment of the invention.

FIG. 13o is a series of images of a water droplet bouncing off an aluminum plate heated above its Leidenfrost temperature, according to an illustrative embodiment of the invention. FIG. 13o (left) shows a droplet bouncing off the surface when the surface is flat (without any ridges); the contact time for this surface was slightly greater than 13 ms.

FIG. 13o (right) shows a droplet impacting the center of 5 spokes, shown in FIGS. 13i-13k. When the drop impacts the center of 5 spokes, the droplet spreads and breaks up into several smaller droplets, which leave the surface in less than 8 ms.

FIGS. 14a and 14b are examples of intersecting ridges or depressions (grooves), according to an illustrative embodiment of the invention.

FIG. 15a illustrates a macro feature that is a cavity/depression, according to an illustrative embodiment of the invention.

FIG. 15b illustrates macro features that form cavities/depressions, according to an illustrative embodiment of the invention.

FIGS. 16a and 16b are schematic illustrations of a curvature macro feature, with (FIG. 16b) and without (FIG. 16a) trapped gas/air, according to an illustrative embodiment of the invention.

FIGS. 17a-17e show top-view images of droplets impacting various surfaces; with the SEM images of their respective microtextures being shown in the right most column, according to an illustrative embodiment of the invention. The surface of FIG. 17a is anodized aluminum oxide with a milled macroscopic texture, pitted microtexture, and a fluorinated coating. FIG. 17b depicts etched copper oxide surface with a milled macroscopic texture, spiked microtexture, and a fluorinated coating. FIG. 17c shows a vein on the wing of a Morpho butterfly (M. didius). FIG. 17d is a vein on a nasturtium leaf (T. majus L.). FIG. 17e illustrates a drop being placed on a lotus leaf, exhibiting axisymmetric recoil. For FIGS. 17a-17e, We=30.

FIGS. 18a-18c show images of an anodized aluminum oxide (AAO) substrate surface at different magnifications, according to an illustrative embodiment of the invention. FIG. 18a shows a top view of the AAO surface showing the macro-scale ridges (height˜100 μm, width˜200 μm); scale bar is 5 mm. FIG. 18b shows a magnified SEM image of a single ridge showing micropits; scale bar is 100 μm. FIG. 18c shows a further magnified SEM image showing nanoscale pores; scale bar is 1 μm.

FIGS. 19a and 19b show images of a copper oxide substrate surface at different magnifications, according to an illustrative embodiment of the invention. FIG. 19a shows a SEM image of the copper oxide nano-textured macro-ridge (height˜100 μm, width˜200 μm); scale bar is 100 μm. FIG. 19b shows a magnified image, showing spiky nano-textures, scale bar is 1 μm.

FIGS. 20a and 20b illustrate the effect of macrotexture on drop impact dynamics and contact time. FIG. 20a is a plot of the contact line position (r, as shown in inset) of a water drop impacting the control surface in FIGS. 2a-2b (red squares) and the macrotextured surface in FIG. 5d (black circles).

FIG. 20b shows that the contact time of a drop on the macrotextured surface (indicated by black dots) depends on where it lands along the periodic macrotexture (indicated by the thick line at the bottom).

FIGS. 21a-21c are schematic diagrams of droplets impinging on a surface.

FIG. 22 includes photographs showing impact of molten tin droplets (250° C.) on microscopically textured silicon substrates without (top row) and with (bottom row) macroscopic ridges. The substrate temperature was 150° C., which is 82° C. below the droplet freezing point. In both the top and the bottom photographs, the droplets are able to bounce off the substrate, although the droplets bounce off the surface with the microscopic ridges significantly faster (6.8 ms vs. 11.9 ms).

FIG. 23 includes images showing impact of molten tin droplets (250° C.) on microscopically textured silicon substrates without contacting (top row) and with contacting (bottom row) a macroscopic ridge. The substrate was maintained at 125° C. (a subcooling of 107° C. below the droplet freezing point). When the tin droplet hit the macroscopic ridge (bottom), the droplet was able to bounce off the surface in 6.8 ms, whereas when impact was not on the ridge (top), the droplet was arrested on the silicon substrate due to solidification of the droplet.

FIG. 24 includes photographs showing impact of molten tin droplets (250° C.) on microscopically textured silicon substrates without (top row) and with (bottom row) ridges. Droplets impacting the ridge surface continued to bounce off until the substrate was cooled to about 50° C., indicating that a significantly large subcooling (˜182° C. below the droplet freezing point) is needed to arrest the droplets on the ridge surface. Droplets impacting the surface without ridges (maintained at 50° C.) were arrested due to solidification.

### DETAILED DESCRIPTION

It is contemplated that compositions, mixtures, systems, devices, methods, and processes of the claimed invention encompass variations and adaptations developed using information from the embodiments described herein. Adaptation and/or modification of the compositions, mixtures, systems, devices, methods, and processes described herein may be performed by those of ordinary skill in the relevant art.

Throughout the description, where devices and systems are described as having, including, or comprising specific components, or where processes and methods are described as having, including, or comprising specific steps, it is contemplated that, additionally, there are systems of the present invention that consist essentially of, or consist of, the recited components, and that there are processes and methods according to the present invention that consist essentially of, or consist of, the recited processing steps.

Similarly, where devices, mixtures, and compositions are described as having, including, or comprising specific compounds and/or materials, it is contemplated that, additionally, there are mixtures and compositions of the present invention that consist essentially of, or consist of, the recited compounds and/or materials.

It should be understood that the order of steps or order for performing certain actions is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

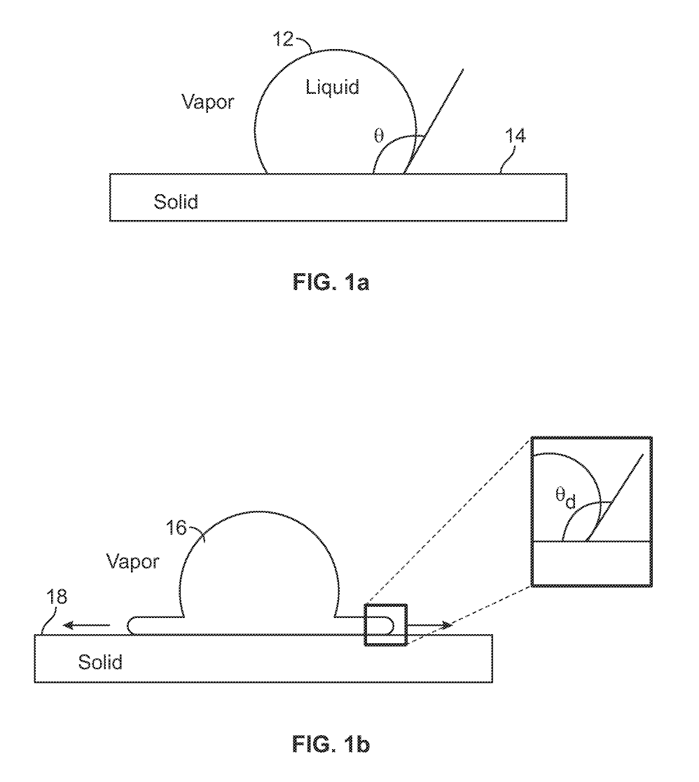

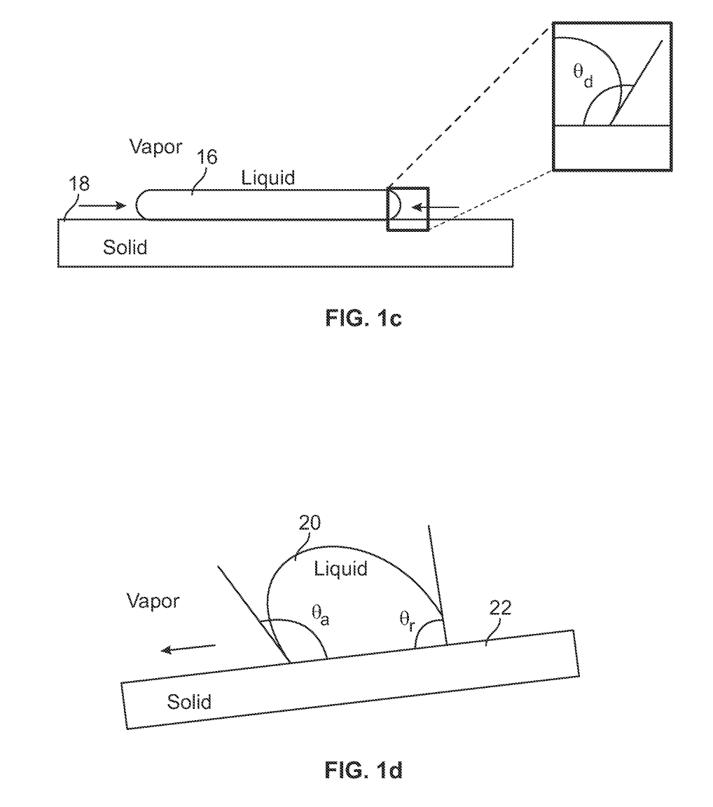

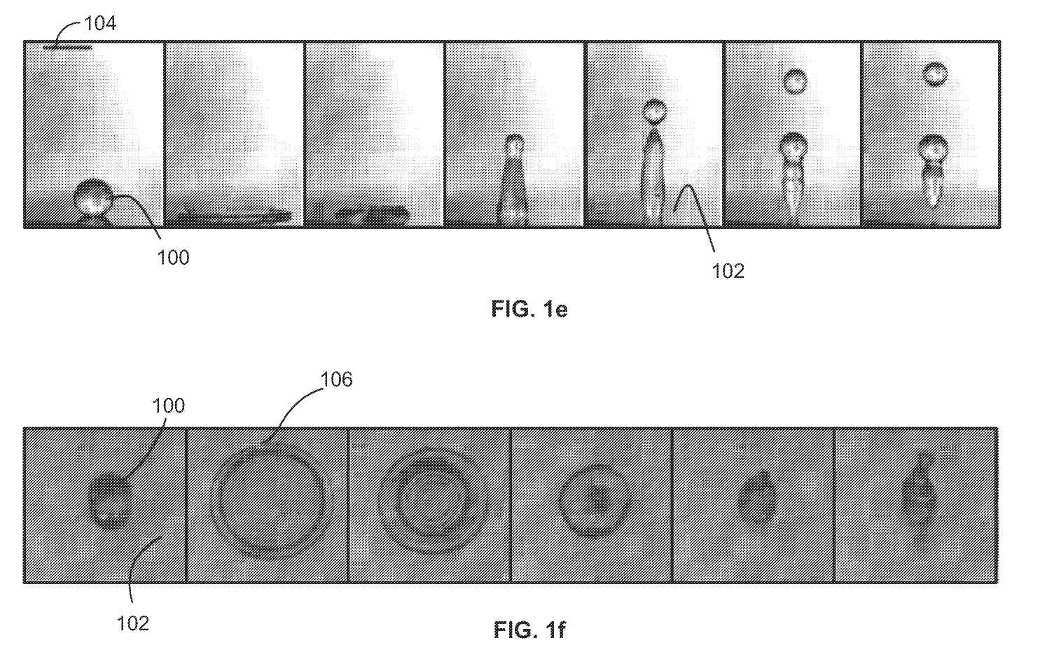

Referring to FIG. 1a, in certain embodiments, a static contact angle θ between a liquid and solid is defined as the angle formed by a liquid drop 12 on a solid surface 14 as measured between a tangent at the contact line, where the three phases—solid, liquid, and vapor—meet, and the horizontal. The term “contact angle” usually implies the static contact angle θ since the liquid is merely resting on the solid without any movement.

As used herein, dynamic contact angle, θ_{d}, is a contact angle made by a moving liquid 16 on a solid surface 18. In the context of droplet impingement, θ_{d} may exist during either advancing or receding movement, as shown in FIGS. 1b and 1c, respectively.

As used herein, a surface is “non-wetting” if it has a dynamic contact angle with a liquid of at least 90 degrees. Examples of non-wetting surfaces include, for example, superhydrophobic surfaces and superoleophobic surfaces.

As used herein, contact angle hysteresis (CAH) is

CAH=θₐ−θᵣ (2)

where θₐ and θᵣ are advancing and receding contact angles, respectively, formed by a liquid 20 on a solid surface 22. Referring to FIG. 1d, the advancing contact angle θₐ is the contact angle formed at the instant when a contact line is about to advance, whereas the receding contact angle θᵣ is the contact angle formed when a contact line is about to recede.

As used herein, “non-wetting features” are physical textures (e.g., random, including fractal, or patterned surface roughness) on a surface that, together with the surface chemistry, make the surface non-wetting. In certain embodiments, non-wetting features result from chemical, electrical, and/or mechanical treatment of a surface. In certain embodiments, an intrinsically hydrophobic surface may become superhydrophobic when non-wetting features are introduced to the intrinsically hydrophobic surface. Similarly, an intrinsically oleophobic surface may become superoleophobic when non-wetting features are introduced to the intrinsically oleophobic surface. Likewise, an intrinsically metallophobic surface may become supermetallophobic when non-wetting features are introduced to the intrinsically metallophobic surface.

In certain embodiments, non-wetting features are micro-scale or nano-scale features. For example, the non-wetting features may have a length scale Lₙ (e.g., an average pore diameter, or an average protrusion height) that is less than about 100 microns, less than about 10 microns, less than about 1 micron, less than about 0.1 microns, or less than about 0.01 microns. Compared to a length scale Lₘ associated with macro-scale features, described herein, the length scales for the non-wetting features are typically at least an order of magnitude smaller. For example, when a surface includes a macro-scale feature that has a length scale Lₘ of 1 micron, the non-wetting features on the surface have a length scale Lₙ that is less than 0.1 microns. In certain embodiments a ratio of the length scale for the macro-scale features to the length scale for the non-wetting features (i.e., Lₘ/Lₙ) is greater than about 10, greater than about 100, greater than about 1000, or greater than about 10,000.

As used herein, a “superhydrophobic” surface is a surface having a static contact angle with water of at least 120 degrees and a CAH of less than 30 degrees. In certain embodiments, an intrinsically hydrophobic material (i.e., a material having an intrinsic contact angle with water of at least 90 degrees) exhibits superhydrophobic properties when it includes non-wetting features. For superhydrophobicity, typically nano-scale non-wetting features are preferred. Examples of intrinsically hydrophobic materials that exhibit superhydrophobic properties when given non-wetting features include: hydrocarbons, such as alkanes, and fluoropolymers, such as teflon, trichloro(1H,1H,2H,2H-perfluorooctyl)silane (TCS), octadecyltrichlorosilane (OTS), heptadecafluoro-1,1,2,2-tetrahydrodecyltrichlorosilane, and fluoroPOSS.

As used herein, a “superoleophobic” surface is a surface having a static contact angle with oil of at least 120 degrees and a CAH with oil of less than 30 degrees. The oil may be, for example, a variety of liquid materials with a surface tension much lower than the surface tension of water. Examples of such oils include alkanes (e.g., decane, hexadecane, octane), silicone oils, and fluorocarbons. In certain embodiments, an intrinsically oleophobic material (i.e., a material having an intrinsic contact angle with oil of at least 90 degrees) exhibits superoleophobic properties when it includes non-wetting features. The non-wetting features may be random or patterned. Examples of intrinsically oleophobic materials that exhibit superoleophobic properties when given non-wetting features include: teflon, trichloro(1H,1H,2H,2H-perfluorooctyl)silane (TCS), octadecyltrichlorosilane (OTS), heptadecafluoro-1,1,2,2-tetrahydrodecyltrichlorosilane, fluoroPOSS, and other fluoropolymers.

In some embodiments, the surface includes a fluoropolymer. In some embodiments, the fluoropolymer is an eco-friendly C6 fluoropolymer. In some embodiments, the C6-type fluoropolymer is selected from the list of materials including, but not limited to 3,3,4,4,5,5,6,6,7,7,8,8,8-tridecafluorooctyl methacrylate; 1H, 1H, 2H, 2H-perfluorooctyl acrylate; 2-(perfluorohexyl) ethyl methacrylate; [N-methyl-perfluorohexane-1-sulfonamide]ethyl acrylate; [N-methyl-perfluorohexane-1-sulfonamide]ethyl (meth) acrylate; 2-(Perfluoro-3-methylbutyl)ethyl methacrylate; 2-[[[[2-(perfluorohexyl) ethyl]sulfonyl]methyl]-amino]ethyl]acrylate; and copolymers thereof. Additional fluoropolymers are discussed in U.S. Patent Application Publication No. 2014/0314982 by Paxson et al., published on Oct. 23, 2014, which is incorporated herein by reference in its entirety.

In some embodiments, the surface (e.g., manufactured surface) includes rare-earth ceramics, for example, as a conformal coating, or the surface itself is made of rare-earth ceramic. In some embodiments, the rare earth ceramic is a hydrophobic rare earth ceramic. In some embodiments, the rare earth ceramic comprises a rare earth material (e.g., rare earth oxide). In some embodiments, the rare earth oxide is a lanthanide series rare earth oxide. In some embodiments, the rare earth oxide is or comprises cerium (IV) oxide (“ceria”). In some embodiments, the rare earth oxide is or comprises erbium (IV) oxide (“erbia”). In some embodiments, the rare earth element material comprises at least one member selected from the group consisting of a rare earth oxide, a rare earth carbide, a rare earth nitride, a rare earth fluoride, and a rare earth boride. In some embodiments, the rare earth element material comprises a combination of one or more species within one or more of the following categories of compounds: a rare earth oxide, a rare earth carbide, a rare earth nitride, a rare earth fluoride, and a rare earth boride.

In some embodiments, the rare earth element material comprises a first rare earth oxide doped with a second rare earth oxide. In some embodiments, the first rare earth oxide is a light rare earth oxide and the second rare earth oxide is a heavy rare earth oxide. In some embodiments, the heavy rare earth oxide includes at least one member selected from the group consisting of gadolinium oxide (Gd₂O₃), terbium oxide (Tb₄O₇), dysprosium oxide (Dy₂O₃), holmium oxide (Ho₂O₃), erbium oxide (Er₂O₃), thulium oxide (Tm₂O₃), ytterbium oxide (Yb₂O₃), and lutetium oxide (Lu₂O₃). In some embodiments, the light rare earth oxide is cerium oxide (CeO₂) and the heavy rare earth oxide is gadolinium oxide (Gd₂O₃).

In some embodiments, the rare earth material includes at least one member selected from the group consisting of scandium (Sc), yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), and lutetium (Lu). In some embodiments, the rare earth material comprises at least one member selected from the group consisting of scandium oxide (Sc₂O₃), yttrium oxide (Y₂O₃), lanthanum oxide (La₂O₃), cerium oxide (CeO₂), praseodymium oxide (Pr₆Oᵢᵢ), neodymium oxide (Nd₂O₃), samarium oxide (Sm₂O₃), europium oxide (Eu₂O₃), gadolinium oxide (Gd₂O₃), terbium oxide (Tb₄O₇), dysprosium oxide (Dy₂O₃), holmium oxide (Ho₂O₃), erbium oxide (Er₂O₃), thulium oxide (Tm₂O₃), ytterbium oxide (Yb₂O₃), and lutetium oxide (Lu₂O₃). In some embodiments, the rare earth element material comprises at least one member selected from the group consisting of cerium carbide (CeC₂), praseodymium carbide (PrC₂), neodymium carbide (NdC₂), samarium carbide (SmC₂), europium carbide (EuC₂), gadolinium carbide (GdC₂), terbium carbide (TbC₂), dysprosium carbide (DyC₂), holmium carbide (HoC₂), erbium carbide (ErC₂), thulium carbide (TmC₂), ytterbium carbide (YbC₂), and lutetium carbide (LuC₂).

In some embodiments, the rare earth material includes at least one member selected from the group consisting of cerium nitride (CeN), praseodymium nitride (PrN), neodymium nitride (NdN), samarium nitride (SmN), europium nitride (EuN), gadolinium nitride (GdN), terbium nitride (TbN), dysprosium nitride (DyN), holmium nitride (HoN), erbium nitride (ErN), thulium nitride (TmN), ytterbium nitride (YbN), and lutetium nitride (LuN). In some embodiments, the rare earth material includes at least one member selected from the group consisting of cerium fluoride (CeF₃), praseodymium fluoride (PrF₃), neodymium fluoride (NdF₃), samarium fluoride (SmF₃), europium fluoride (EuF₃), gadolinium fluoride (GdF₃), terbium fluoride (TbF₃), dysprosium fluoride (DyF₃), holmium fluoride (HoF₃), erbium fluoride (ErF₃), thulium fluoride (TmF₃), ytterbium fluoride (YbF₃), and lutetium fluoride (LuF₃).

In some embodiments, the rare earth material includes at least one member selected from the group consisting of cerium boride (CeB₆), praseodymium boride (PrB₆), neodymium boride (NdB₆), samarium boride (SmB₆), europium boride (EuB₆), gadolinium boride (GdB₆), terbium boride (TbB₆), dysprosium boride (DyB₆), holmium boride (HoB₃), erbium boride (ErB₆), thulium boride (TmB₆), ytterbium boride (YbB₆), and lutetium boride (LuB₆).

Rare earth ceramics and their applications are discussed in further detail in U.S. Patent Application Publication No. 2013/0251942 to Azimi et al., published Sep. 26, 2013, which is incorporated herein by reference in its entirety.

As used herein, a “supermetallophobic” surface is a surface having a static contact angle with a liquid metal of at least 120 degrees and a CAH with liquid metal of less than 30 degrees. In certain embodiments, an intrinsically metallophobic material (i.e., a material having an intrinsic contact angle with liquid metal of at least 90 degrees) exhibits supermetallophobic properties when it includes non-wetting features. The non-wetting features may be random or patterned. Examples of intrinsically metallophobic materials that exhibit supermetallophobic properties when given non-wetting features include: teflon, trichloro(1H,1H,2H,2H-perfluorooctyl)silane (TCS), octadecyltrichlorosilane (OTS), heptadecafluoro-1,1,2,2-tetrahydrodecyltrichlorosilane, fluoroPOSS, and other fluoropolymers. Examples of metallophobic materials include molten tin on stainless steel, silica, and molten copper on niobium.

In certain embodiments, intrinsically hydrophobic materials and/or intrinsically oleophobic materials include ceramics, polymeric materials, fluorinated materials, intermetallic compounds, and composite materials. Polymeric materials may include, for example, polytetrafluoroethylene, fluoroacrylate, fluorourethane, fluorosilicone, fluorosilane, modified carbonate, chlorosilanes, silicone, and/or combinations thereof. Ceramics may include, for example, titanium carbide, titanium nitride, chromium nitride, boron nitride, chromium carbide, molybdenum carbide, titanium carbonitride, electroless nickel, zirconium nitride, fluorinated silicon dioxide, titanium dioxide, tantalum oxide, tantalum nitride, diamond-like carbon, fluorinated diamond-like carbon, and/or combinations thereof. Intermetallic compounds may include, for example, nickel aluminide, titanium aluminide, and/or combinations thereof.

As used herein, an intrinsic contact angle is a static contact angle formed between a liquid and a perfectly flat, ideal surface. This angle is typically measured with a goniometer. The following publications, which are hereby incorporated by reference herein in their entireties, describe additional methods for measuring the intrinsic contact angle: C. Allain, D. Aussere, and F. Rondelez, J. Colloid Interface Sci., 107, 5 (1985); R. Fondecave, and F. Brochard-Wyart, Macromolecules, 31, 9305 (1998); and A. W. Adamson, Physical Chemistry of Surfaces (New York: John Wiley & Sons, 1976).

When a liquid droplet impacts a non-wetting surface, the droplet will spread out on the surface and then begin to recoil. For highly non-wetting surfaces, the droplet can completely rebound from the surface. Through the impact dynamics, the shape of the droplet is generally axisymmetric so that, at any point in time during recoil, the wetted area is substantially circular. By patterning the surface, however, this symmetry may be disrupted and the impact dynamics may be altered or controlled. For example, by controlling or defining macro-scale features on the surface, the contact time of the droplet may be increased or decreased, instabilities may be created that cause the droplet to break-up into smaller droplets, and spatial control may be gained over how long a particular drop, or part of that drop, is in contact with the surface.

During the time of contact between a droplet and a surface, heat, mass, and momentum diffuse between the droplet and the surface. By controlling the time that a droplet contacts a particular location on the surface, this diffusion may be optimized both temporally and spatially. In certain embodiments, surface patterns or features are developed that influence the recoil of droplets in two distinct ways: (1) patterns that introduce concavity to the receding boundary, and (2) patterns that introduce surface curvature to the film in such a way that capillary pressure delaminates the spread-out droplet from the surface.

The speed at which a spread-out droplet recedes depends not only on the material properties of the droplet, but also the properties of the surface the droplet contacts. On non-wetting surfaces, the drop recoiling speed is reduced by the dissipation or contact angle hysteresis from the surface. Variations in dissipation may be achieved by changing the structure and/or chemistry of the surface patterns that form the non-wetting surface. For example, the density of patterns such as posts can influence the recoiling speed of drops. Dissipation in the system may be added using a variety of tools, such as flexible structures at various length scales. In addition, while a pattern of posts can break the symmetry of receding films, the drops may remain convex.

In certain embodiments, surfaces are designed that introduce concavity into the receding film. Using these designs, the surfaces are tailored so that the exposure to droplets in certain regions is longer than it is in other regions. In one embodiment, concavity breaks the film into separate drops, and the concavity is augmented by natural capillary instabilities. For example, the surface may be patterned so the recoil of the drop in one direction is significantly slower than in a perpendicular direction. The resulting recoil forms a cylinder which quickly becomes concave and breaks up into droplets via a Rayleigh-Plateau type instability.

A limitation in the surface pinning approach is that it may slow down the drop dynamics. The minimum contact time a drop makes with a surface is believed to be minimized when that surface approaches a 180 degree contact angle with no contact angle hysteresis, the equivalent of impacting on a thin air layer. As described herein, however, a shorter contact time is possible using patterned surfaces. Specifically, if during the recoiling stage, the contact line increases while the surface area decreases, there are more fronts on which the droplet can recoil. It is therefore possible for the drop to recede more quickly than if the drop were receding symmetrically, so that the total contact time for the drop is reduced. As described below, in certain embodiments, concavity is introduced by speeding up the recoil of portions of the receding film.

FIGS. 1a and 1b depict side and top views, respectively, of a water droplet 100 bouncing on a superhydrophobic surface 102. The surface 102 includes an array of 10 μm square posts of silicon spaced 3 μm apart. The contact time in this case, measured from the leftmost image to the rightmost in these figures, is about 19 ms. The scale bar 104 in the leftmost image of FIG. 1a is 3 mm. FIG. 1b shows that the droplet spreads and recedes with a largely symmetrical (circular) edge 106.

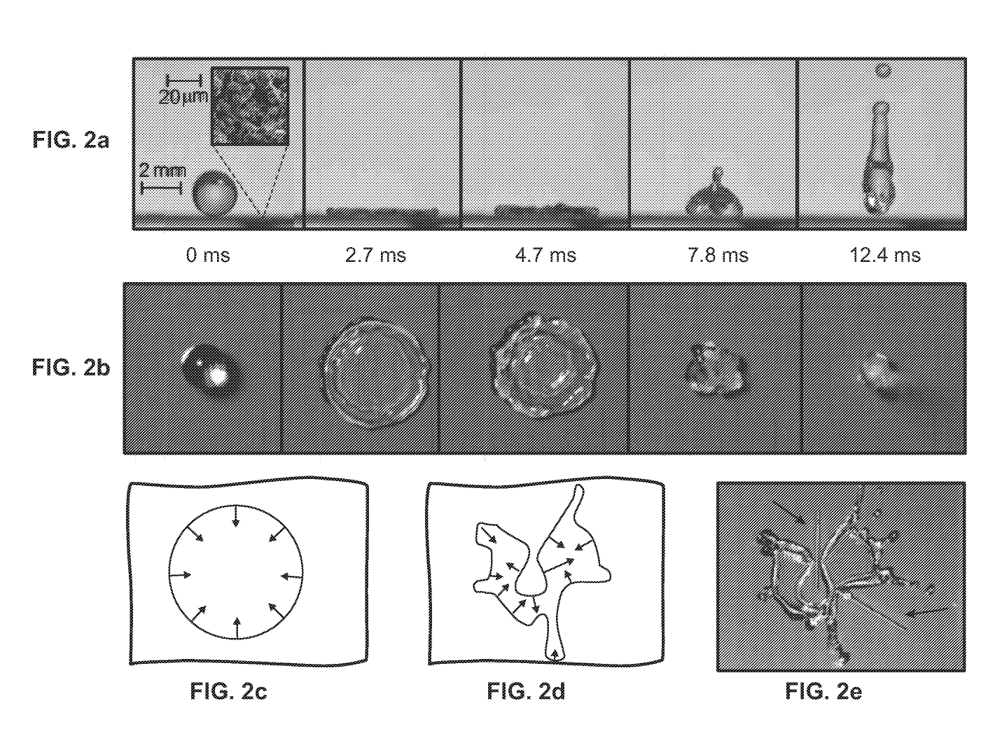

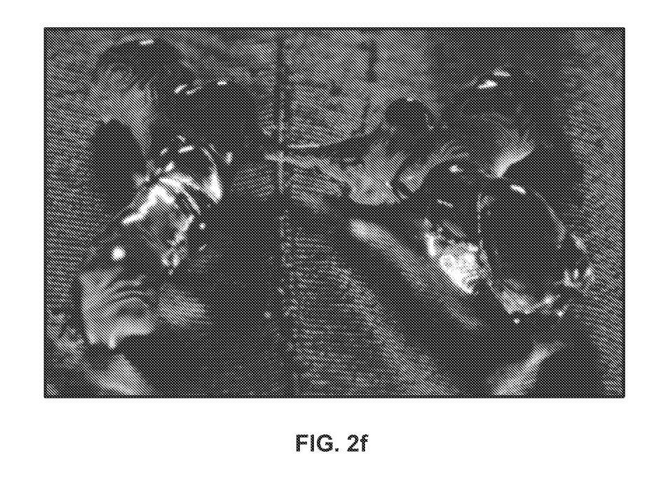

FIGS. 2a-b show images of experiments that involved releasing a water drop (radius R=1.33 mm, velocity U=1.2 m s⁻¹) onto a superhydrophobic surface and filming the bounce dynamics with high-speed cameras (FIG. 2a). The surface used was a laser-ablated silicon wafer coated with fluorosilane, with chemical hydrophobicity and microscopic texture ensuring its superhydrophobic character (FIG. 2a inset). On this surface, the impacting drop viewed from the side (FIG. 2a) spreads to a nearly uniform film, retracts, and then lifts off within 12.4 ms. Simultaneously acquired top-view images show nearly axisymmetric dynamics throughout the process (FIG. 2b), consistent with past experiments. The retraction time represents a significant portion of the contact time. For bouncing drops, inertial forces generally dominate viscous forces; thus, the retraction occurs predominantly at the film edge (as shown schematically in FIG. 2c). When the film is axisymmetric and uniformly thick, the edge retracts inward at a constant velocity and the centre remains stationary (as shown schematically in FIG. 2c). This retraction velocity decreases with certain texture-liquid interactions (such as pinning), thereby increasing the contact time. Theoretical models suggest that the shortest contact time is on a surface with the sparsest texture necessary to trap a thin layer of air. As this limit is approached, the drop dynamics become increasingly axisymmetric. Therefore, it has been assumed that the minimum contact time should occur for a drop that recoils axisymmetrically with a centre that remains stationary until engulfed by the retracting rim.

The findings described herein challenge this tacit assumption by presenting, in some embodiments, a novel alternative: non-axisymmetric recoil, or more precisely, centre-assisted recoil. If the hydrodynamics are altered such that the drop retracts with the liquid near the centre assisting with the recoil (e.g., as shown schematically in FIG. 2d), it is possible to further reduce the contact time below the theoretical limits provided in Equation 1 above. To activate the drop centre, designed macro textures are added to the non-wetting surface in order to trigger a controlled asymmetry and non-uniform velocity field (FIG. 2d) in the retracting film. The combination of faster velocities and smaller distances along certain directions reduces contact time below that of the axisymmetric case (e.g., as shown in FIGS. 2a-2b). This concept was experimentally demonstrated, for example, by embossing a macrotexture (arrows in FIG. 2e) with an amplitude comparable, but less than, the film thickness.

In certain embodiments, the devices and methods presented herein reduce the contact time between an impinging droplet and a surface by modifying surface textures associated with the surface. Surprisingly, these devices and methods reduce the contact time to below the theoretical limit indicated by Equation 1, above. In one embodiment, by appropriately designing the superhydrophobic surface, contact times are further decreased to about one half of this theoretical limit.

In certain embodiments, the devices and methods described herein incorporate macro-scale features (e.g., ridges, sinusoids, protrusions) into a superhydrophobic surface to trigger controlled asymmetry in the liquid film produced by droplet impingement. The macro-scale features may have, for example, a height greater than about 0.00001 mm, greater than about 0.0001 mm, greater than about 0.001 mm, greater than about 0.01 mm, greater than about 0.1 mm, or greater than about 1 mm. Additionally, the macro-scale features may have, for example, a spacing (e.g., a spacing between ridges, peaks, or valleys) greater than about 0.00001 mm, greater than about 0.0001 mm, greater than about 0.001 mm, greater than about 0.01 mm, greater than about 0.1 mm, or greater than about 1 mm.

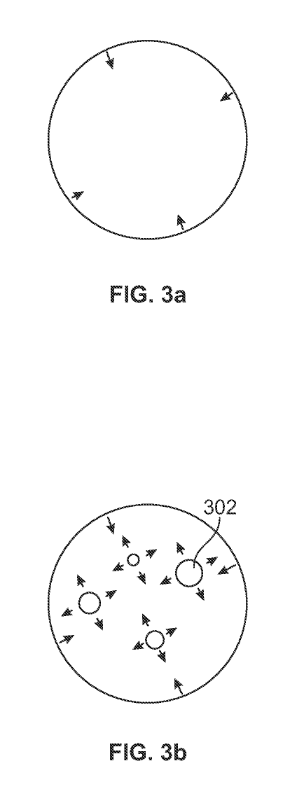

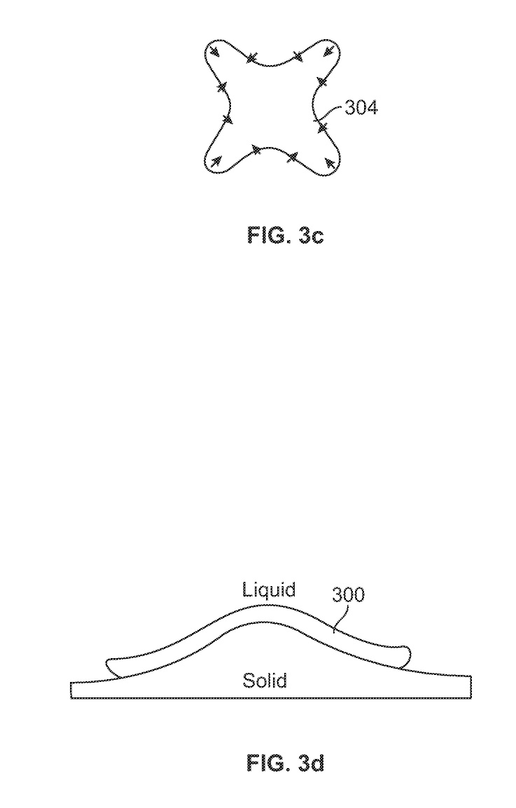

Referring to FIGS. 3a-3d, the asymmetry in a liquid film 300, in the form of cracks 304, holes 302, and curvature, introduced by the macro-scale features, leads to droplet recoiling at multiple fronts and, hence, produces a significant reduction in the contact time. This idea is distinctly different from previous approaches which typically included smaller features (e.g., 100 nm) and, more importantly, attempted to minimize the contact line pinning between the drop and these features.

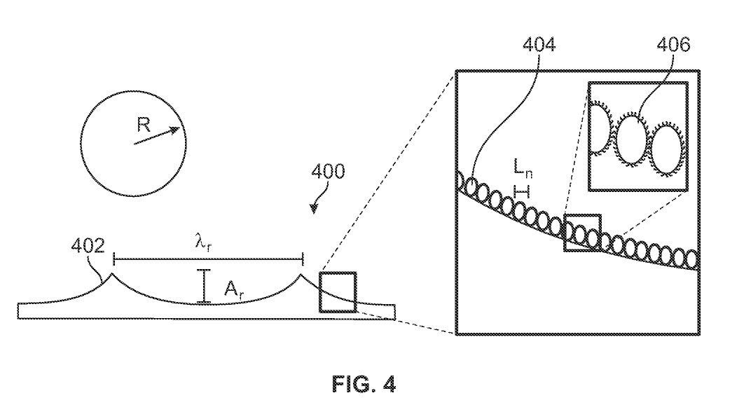

In one embodiment, shown in FIG. 4, a superhydrophobic surface 400 includes macro-scale ridges 402 that trigger cracks in a liquid film upon impingement of a droplet having radius R. As depicted in FIG. 4, the ridges 402 have a ridge height Aᵣ and a ridge spacing λᵣ. The ridges 402 may have any cross-sectional shape, including, for example, curved and pointed (as shown in FIG. 4), triangular, hemispherical, and/or rectangular. Typically, each ridge 402 has a ridge length (along the surface 400) that is much greater than the ridge height Aᵣ and/or ridge spacing λᵣ. For example, a ridge 402 may have a ridge height Aᵣ of about 0.1 mm and a ridge length (e.g., along a ridge longitudinal axis) of about 100 mm or more. To achieve or maintain superhydrophobicity, the surface 400 includes non-wetting features 404 having a length scale Lₙ (e.g., an average diameter or cross-dimension). In certain embodiments, the non-wetting features 404 are chosen so that θ_{d} is greater than 90 degrees and CAH is less than about 30 degrees, less than about 20 degrees, or less than about 10 degrees. As depicted, the non-wetting features may include smaller features 406, if necessary, to facilitate non-wetting.

Referring again to FIGS. 1b and 1c, when a liquid droplet impinges a solid surface, the droplet spreads into a thin lamella or film having a thickness h. In certain embodiments, a ratio of the ridge height Aᵣ to the thickness h (i.e., Aᵣ/h) is greater than about 0.01. For example, Aᵣ/h may be from about 0.01 to about 100, from about 0.1 to about 10, or from about 0.1 to about 5. In certain embodiments, a ratio of the ridge spacing λᵣ to the ridge height Aᵣ is greater than or equal to about 1.

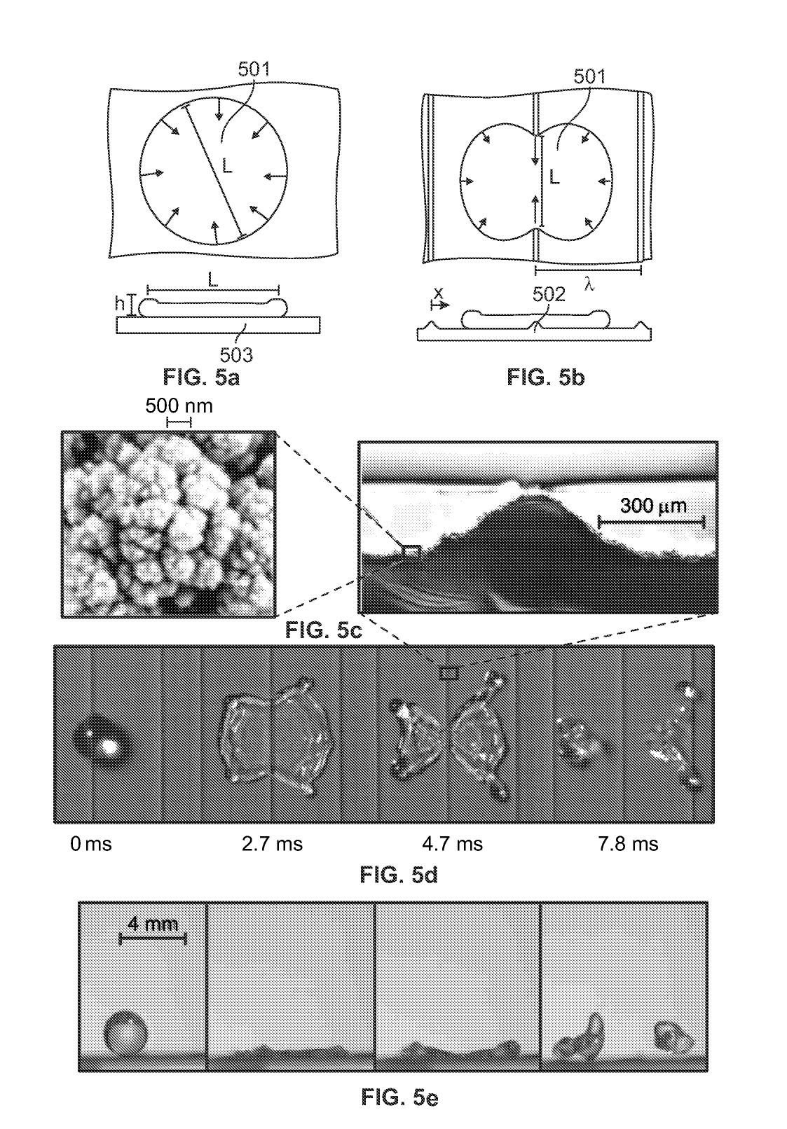

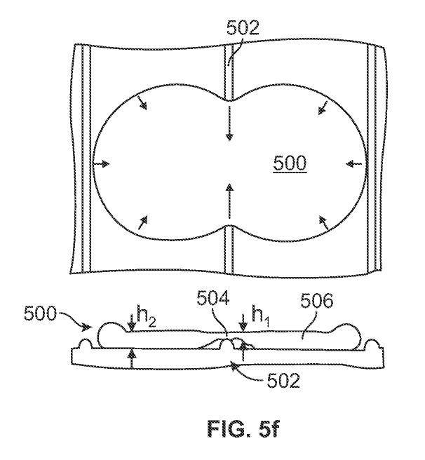

FIGS. 5a and 5b are schematic diagrams showing a droplet 501 recoiling on a flat surface 503 and a droplet 500 recoiling on a ridge 502, respectively. As depicted, on the flat surface 503 of FIG. 5a, droplet recoil is typically axisymmetric, with the droplet 501 remaining substantially circular over the entire time (impact and recoil). If the thickness h of the flattened drop were uniform, the rim retracts axisymmetrically with speed V=\sqrt{2γ/ρh} (as illustrated schematically in FIG. 5a), where γ is the liquid-air surface tension and ρ is the liquid density.

By comparison, on the ridge 502 of FIGS. 5f and 5b, droplet recoil is asymmetric. As shown in FIG. 5f, thinner portions 504 (having thickness hᵢ) at the ridge 502 recoiled faster than thicker portions 506 (having thickness h₂) adjacent to the ridge 502. The thinner portions 504 may be referred to as cracks. As depicted in FIG. 5f, the ridges 502 create cracks or pathways that promote droplet fracture. These pathways cause the contact line to penetrate into the droplet 500 along the ridge 502, thereby increasing the contact line length during droplet recoil and reducing contact time.

FIG. 5c shows a superhydrophobic surface with two distinct length scales. The smaller length scale includes hierarchical micrometre-scale and nanometre-scale features identical to those used in FIGS. 2a-b, imparting superhydrophobicity with minimal pinning. The larger length scale includes macroscopic features approaching the length scale of the film thickness h (FIG. 5f) for modifying the retraction hydrodynamics. The macro texture height z varies as z=a sinₙ(x/λ), where x is the horizontal distance, a=150 mm, n=100, and 1=4 mm.

Top-view images of a drop recoiling on the macrotexture show faster retraction along the ridge than in other directions (FIG. 5d). This variation in speed breaks the radial symmetry of the recoiling film, causing the liquid to move rapidly inward along the ridge such that more of the film participates in the recoil. As shown in FIGS. 5d and 5e, the drop is not split before impact, but divides during recoil as a result of the modified hydrodynamics. On the macrotextured surface of FIGS. 5d and 5e, the radial symmetry of the droplet is broken, creating a zipping effect that reduces the overall contact time. Synchronized side-view images of this drop (FIG. 5e) verify that the overall contact time (7.8 ms) is less than that on the same surface without the macrotextures (FIG. 2b—with the contact time of 12.4 ms).

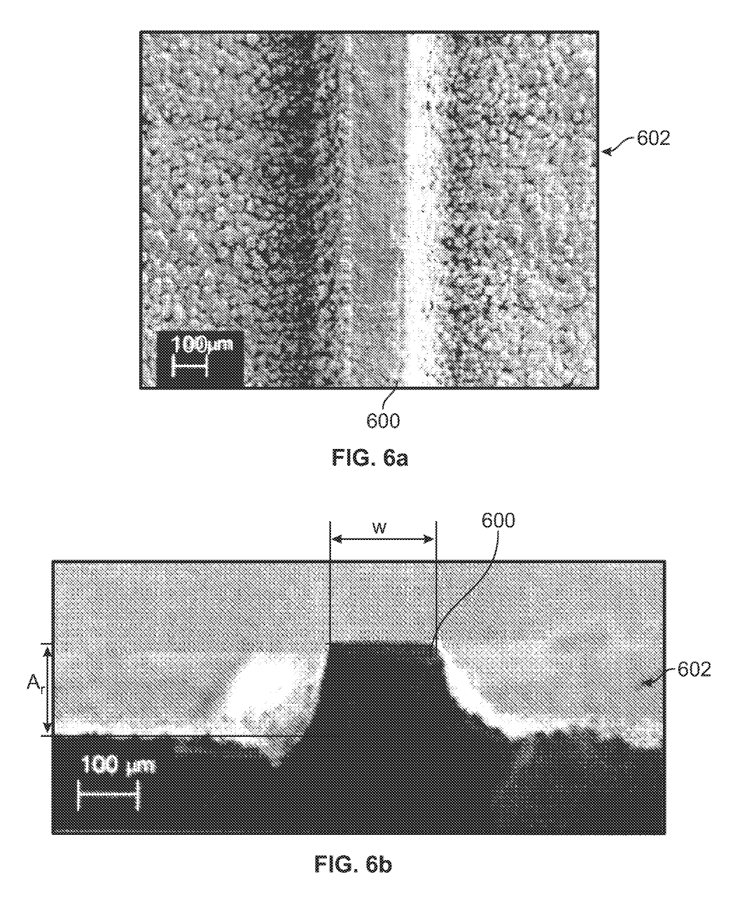

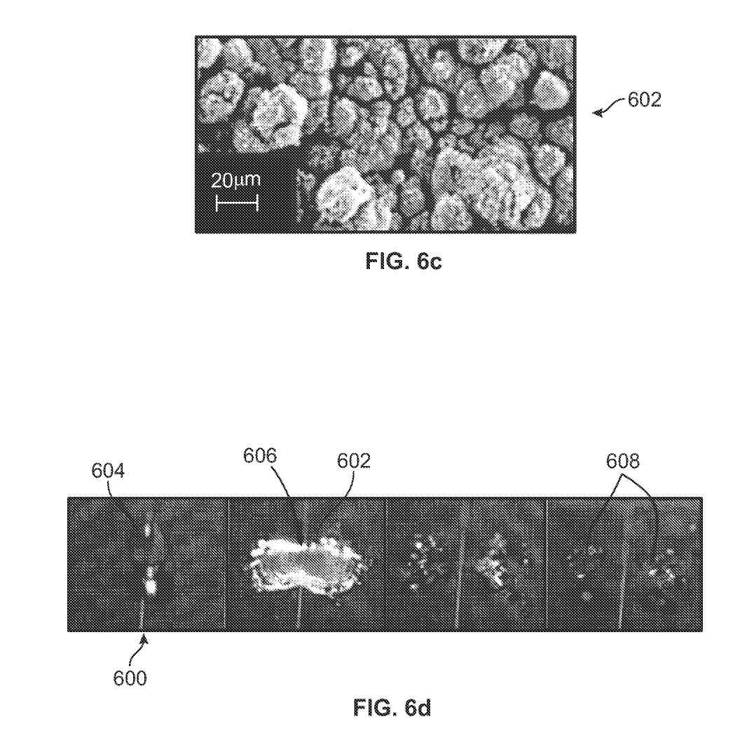

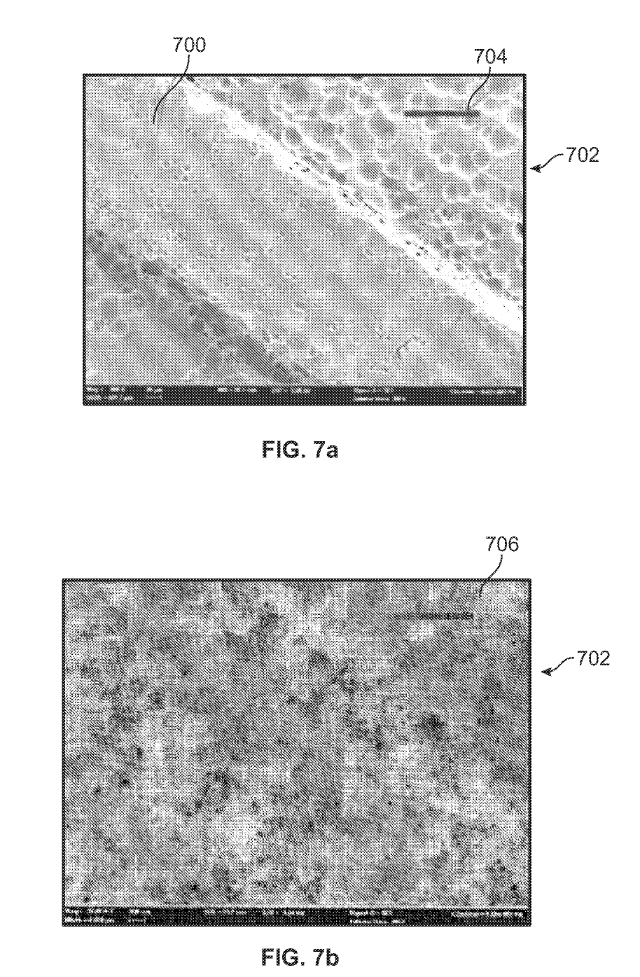

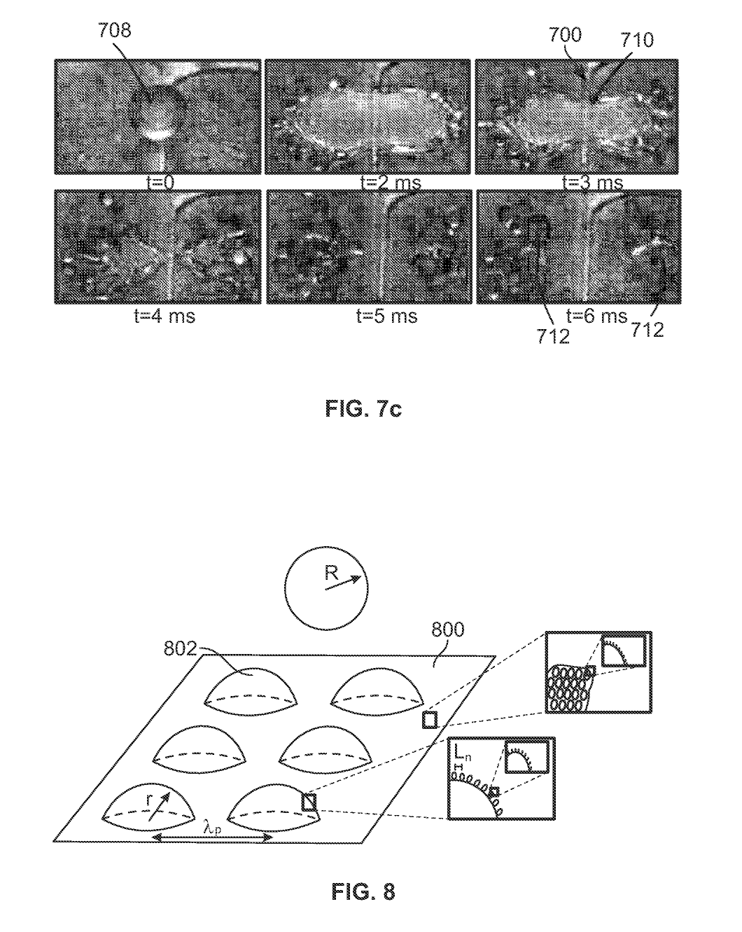

FIGS. 6a-6d and 7a-7c depict experimental examples of surfaces for triggering cracks in a liquid film upon droplet impingement, in accordance with certain embodiments of the invention. FIGS. 6a-6d show photographs of droplet impingement on a ridge 600 fabricated on a silicon surface 602 using laser-rastering. FIGS. 7a-7c show droplet impingement on a ridge 700, of similar dimensions, milled on an aluminum surface 702, followed by anodization to create nano-scale pores. Both surfaces 602, 702 were made superhydrophobic by depositing trichloro(1H,1H,2H,2H-perfluorooctyl)silane. The diameter of the droplet before impingement was 2.6 mm (i.e., R=1.3 mm) and the impact velocity was 1.8 m/s.

FIGS. 6a-6c show the details of the silicon surface 602 with the help of SEM images of the ridge 600, which had a ridge height Aᵣ of about 150 μm and width W of about 200 μm. These figures also show the non-wetting features achieved to maintain superhydrophobicity. The dynamics of droplet impingement are shown in FIG. 6d, which reveals that a droplet 604 deforms asymmetrically and develops a crack 606 along the ridge 600. The crack 606 creates additional recoiling fronts which propagate rapidly along the ridge 600 until the film is split into multiple drops 608. The contact time in this case was only 7 ms—almost one-third of the contact time for the example shown in FIG. 1, and about 50% less than the theoretical prediction from Equation 1 (i.e., 13.5 ms) with ϕ=0.

As mentioned above, the ridges may have any cross-sectional shape, including the approximately rectangular cross-section depicted in FIG. 6a. Additionally, a ratio of the ridge height Aᵣ to the width W (i.e., Aᵣ/W) may be, for example, from about 0.1 to about 10.

FIGS. 7a-7c show similar contact time reduction achieved on the anodized aluminum oxide (AAO) surface 702. The contact time in this case was about 6.3 ms, which is over 50% smaller than the theoretical prediction of Equation 1 (i.e., 13.5 ms). The details of the surface 702 are shown in FIGS. 7a and 7b with the help of SEM images revealing the ridge texture and the nanoporous structure. The scale bars 704, 706 in FIGS. 7a and 7b are 100 μm and 1 μm, respectively. Referring to FIG. 7c, the dynamics of droplet impingement show behavior similar to that seen on the laser-rastered silicon surface. For example, a droplet 708 deforms asymmetrically with a crack 710 developing along the ridge 700, thereby causing the liquid film to recoil rapidly along the ridge 700 and split into multiple drops 712.

In certain embodiments, the reduction of contact time, as shown in the examples in FIGS. 6a-6d through 7a-7c, is more a result of surface design or structure, rather than the surface material or other surface property. For example, although the surfaces in these examples were produced by completely different methods (i.e., laser-rastering in FIG. 6a-6d, and milling and anodizing in FIGS. 7a-7c), the similar macro-scale features (e.g., ridge size and shape) of the two surfaces resulted in similar drop impingement dynamics.

In another embodiment, a superhydrophobic surface 800 includes macro-scale protrusions 802 that nucleate holes in a liquid film upon impingement of a droplet having radius R. The protrusions 802 may have any shape, including spherical, hemispherical, dome-shaped, pyramidal, cube-shaped, and combinations thereof. For example, in the embodiment depicted in FIG. 8, the protrusions 802 are substantially dome-shaped with a protrusion height Aₚ and are spaced in grid with a protrusion spacing λₚ. To achieve or maintain superhydrophobicity, the surface 800 includes non-wetting features having a length scale Lₙ. As mentioned above, the non-wetting features are chosen so that θ_{d} is greater than 90 degrees and CAH is less than about 30 degrees, less than about 20 degrees, or less than about 10 degrees.

In certain embodiments, a ratio of the protrusion height Aₚ to the lamella or film thickness h (i.e., Aₚ/h) is greater than or equal to about 0.01. For example, Aₚ/h may be from about 0.01 to about 100, or from about 0.1 to about 10, or from about 0.1 to about 3. In certain embodiments, a ratio of the protrusion spacing λₚ to the protrusion height Aₚ (i.e., λₚ/Aₚ) is greater than or equal to about 2.

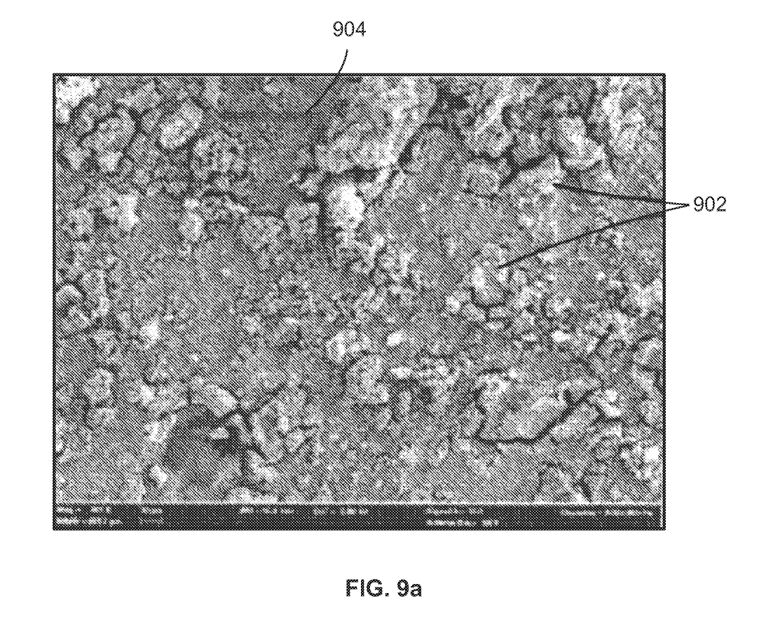

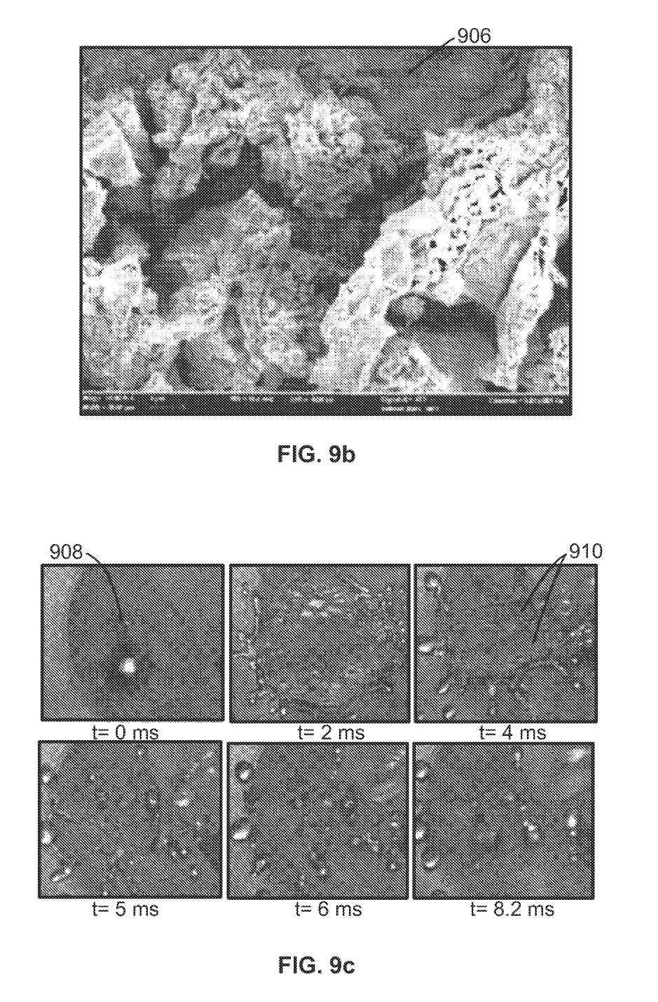

FIGS. 9a-9c depict an example surface 900 that includes macro-scale protrusions 902 for nucleating a droplet upon impingement. The surface 900 in this example is made of anodized titanium oxide (ATO). Details of the surface 900 are shown in the SEM images. The scale bars 904, 906 in FIGS. 9a and 9b are 100 μm and 4 μm, respectively. As depicted, the surface includes macro-scale protrusions 902, of about 20-100 μm, which further contain non-wetting features to maintain superhydrophobicity. Referring to the high-speed photography images in FIG. 9c, after a droplet 908 impinges the ATO surface (at t=0), the droplet 908 spreads into a thin film (at t=2 ms) that destabilizes internally and nucleates into several holes 910 (at t=4 ms). The holes 910 grow until their boundaries meet or collide, thereby causing fragmentation of the entire film. Each hole 910 creates additional fronts where the film may recoil, thus resulting in a significant reduction in contact time. The contact time in this example was about 8.2 ms, which is again much smaller than the theoretical prediction (i.e., 13.5 ms) from Equation 1 with ϕ=0.

In the depicted embodiments, the protrusions increase the contact line of the droplet by introducing holes in the droplet. The holes increase or open during recoil, thereby reducing the contact time.

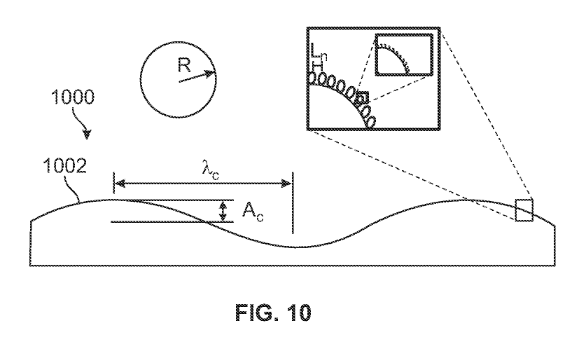

In another embodiment, a superhydrophobic surface 1000 includes macro-scale curved profiles 1002 that introduce curvature in a liquid film upon impingement of a droplet having radius R. The curved profiles 1002 may have any shape, including sinusoidal and/or parabolic (e.g., piece-wise). Compared to the ridges 402 and protrusions 802, described above, the curved profiles 1002 are generally smoother, with less abrupt variations in surface height. For example, in the embodiment depicted in FIG. 10, the curved profiles 1002 define a sinusoidal pattern of peaks and valleys on the surface. The sinusoidal pattern has a wave amplitude A_{c} and a wave spacing λ_{c} (i.e., the distance from a peak to a valley). The wave spacing λ_{c} may also be referred to as half the period of the sinusoidal pattern.

In certain embodiments, the surface 1000 includes curvature along more than one direction. For example, a height of surface 1000 may vary sinusoidally along one direction and sinusoidally along another, orthogonal direction.

To achieve or maintain superhydrophobicity, the surface 1000 includes non-wetting features having a length scale Lₙ. As mentioned above, the non-wetting features are chosen so that θ_{d} is greater than 90 degrees and CAH is less than about 30 degrees, less than about 20 degrees, or less than about 10 degrees.

In certain embodiments, a ratio of the wave amplitude A_{c} to the thickness h (i.e., A_{c}/h) is greater than or equal to about 0.01. For example, A_{c}/h may be from about 0.01 to about 100, or from about 0.1 to about 100, or from about 0.1 to about 50, or from about 0.1 to about 9. In certain embodiments, a ratio of the wave spacing λ_{c} to the wave amplitude A_{c} (i.e., λ_{c}/A_{c}) is greater than or equal to about 2. For example, λ_{c}/A_{c} may be from about 2 to about 500, or from about 2 to about 100.

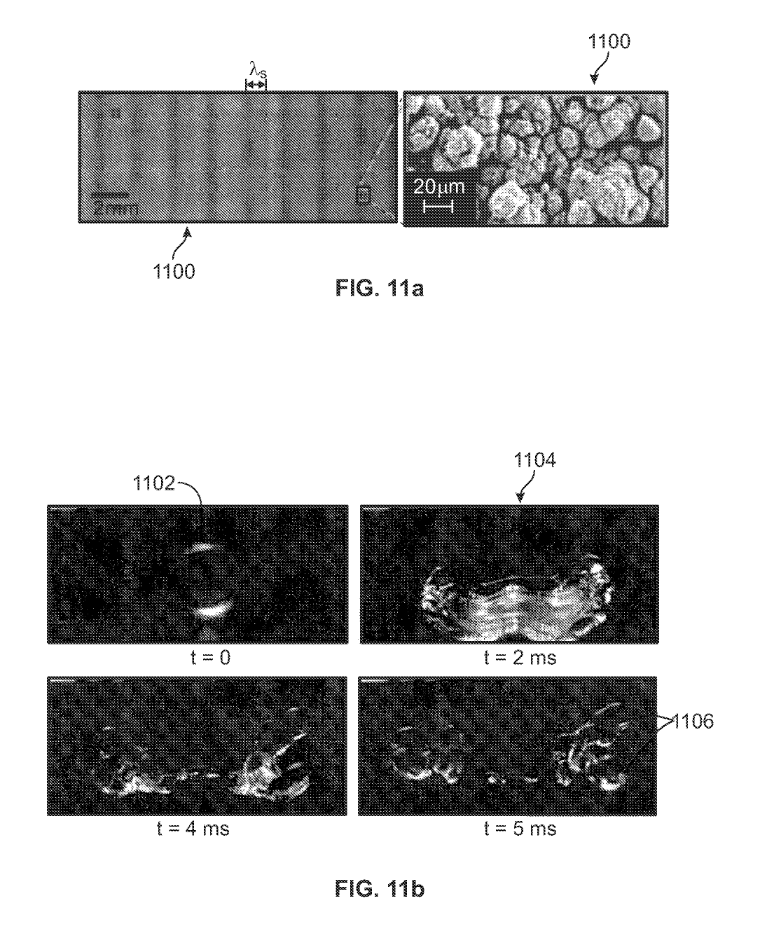

FIG. 11a depicts an example of a sinusoidal curved surface 1100 fabricated on silicon using laser rastering. The details of the surface 1100 are shown with the help of SEM images. The wave amplitude A_{c} of the sinusoidal pattern was about 350 μm while its period (i.e., twice the wave spacing λ_{c}) was 2 mm. The surface 1100 was made superhydrophobic by depositing trichloro(1H,1H,2H,2Hperfluorooctyl)silane. Referring to FIG. 11b, the dynamics of droplet impingement on the surface 1100 reveal that a droplet 1102 adopts the curved profile of the surface 1100 while spreading and becomes a thin film of varying thickness. The film thickness is smallest at a crest or peak 1104 of the sinusoidal surface 1100 where the film recedes fastest, thereby causing the film to split across the crest 1104 and break into multiple drops 1106. The contact time in this example was only about 6 ms, which is again well over 50% smaller than the theoretical prediction of Equation 1 (i.e., 13.5 ms).

As described above with respect to FIGS. 10, 11a, and 11b, in certain embodiments, the contact time of the drop is reduced by controlling the local curvature of the surface. If the surface is curved so that part of the film covers a concave region, one of two scenarios may occur—both of which decrease the total contact time of the film on the surface. In one scenario, the film spreads over the concavity so that the thickness is nearly uniform. If the film is making contact with the curved surface, then the film is also curved, in which case the film curvature, along with surface tension, causes a pressure gradient that lifts the film off of the surface as quickly as the edges recoil. In the other scenario, the film spreads over the concavity in a way that the film surface is flat (i.e., not curved). In this case the film thickness is not uniform and, along contours where the film is thinner, the drop recoils more quickly than along areas where the film is thicker. As discussed above, by forming a hybrid surface of linked concave cusps, the contact time may be reduced below the theoretical limit defined by Equation 1.

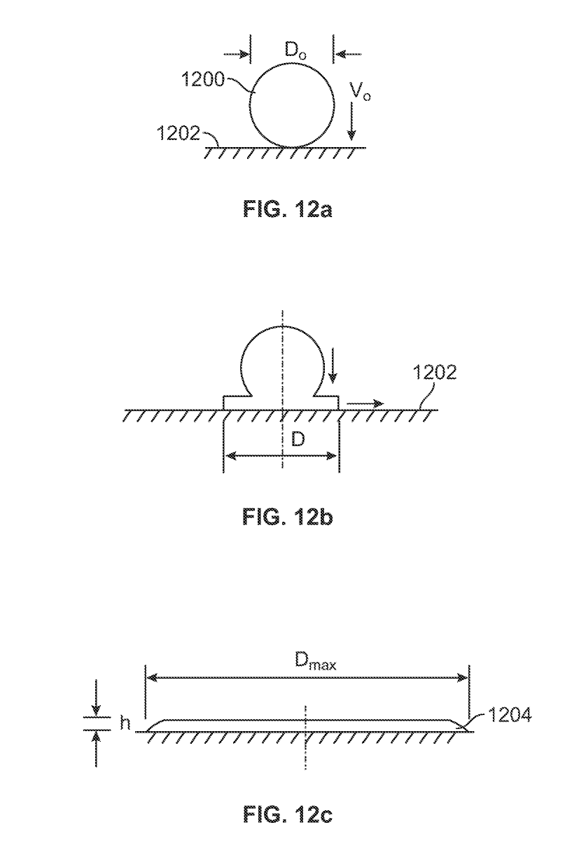

When a liquid droplet 1200 of diameter Dₒ impinges a solid surface 1202 with velocity Vₒ, the droplet 1200 spreads into a thin lamella (film) 1204 of thickness h, eventually reaching a maximum diameter Dₘₐₓ, as shown in FIGS. 12a, 12b, and 12c. h can be estimated by applying mass conservation at the spherical droplet state, shown in FIG. 12a, and the lamella state, shown in FIG. 12c, with the assumptions that there is negligible mass loss (e.g., due to splashing or evaporation) during spreading and the lamella 1204 is substantially uniform in thickness in time and space, on average. With these assumptions, the mass of the droplet 1200 when equated at the spherical droplet state and the lamella state yields:

$$ρ \frac{π}{6} {D}_{o}^{3} = ρ \frac{π}{4} {D}_{max}^{2} h , \qquad ( 3 )$$

where ρ is the density of droplet liquid. Solving Equation 3 for h gives:

$$h = \frac{2 {D}_{o}}{3 {ξ}_{max}^{2}} , \qquad ( 4 )$$

where ξₘₐₓ=Dₘₐₓ/Dₒ is the maximum spread factor of the impinging droplet. To calculate ξₘₐₓ, an energy balance model may be used. According to this model, ξₘₐₓ is given as:

$${ξ}_{max} = \sqrt{\frac{We + 12}{3 ( 1 - cos {θ}_{a} ) + 4 ( We / \sqrt{Re} )}} , \qquad ( 5 )$$

where θₐ is the advancing contact angle formed by a droplet of liquid on the solid surface 1202, We=ρVₒ²Dₒ/γ is the droplet Weber number, and Re=ρVₒDₒ/μ is the droplet Reynolds number before impingement. Here γ and μ are the surface tension and dynamic viscosity of the droplet liquid, respectively. Equation 5 can be simplified further by approximating the value of expression 3(1−cos θₐ) to 6 as θₐ, at maximum, can be 180°. With this simplification, Equation 5 becomes:

$${ξ}_{max} = \sqrt{\frac{We + 12}{6 + 4 ( We / \sqrt{Re} )}} , \qquad ( 6 )$$

Thus, once ξₘₐₓ is calculated from Equation 6, h can be estimated using Equation 4. The devices and methods described herein have a wide range of applications, including rainproof products, wind turbines, steam turbine blades, aircraft wings, and gas turbine blades. Table 1 presents typical droplet radius values for several of these applications. As indicated, for rainproof products and wind turbine applications, droplet radius values may be from about 0.1 mm to about 5 mm. Similarly, for steam turbine blades, aircraft icing, and gas turbine blade applications, droplet radius values may be from about 0.01 mm to about 5 mm. In one embodiment, for rainproof products and wind turbine applications, lamella thickness values are from about 0.01 mm to about 1 mm, and ξₘₐₓ values are from about 5 to about 100. In another embodiment, for steam turbine blades, aircraft icing, and gas turbine blade applications, lamella thickness values are from about 0.001 mm to about 1 mm, and ξₘₐₓ values are from about 10 to about 500.

In certain embodiments, Table 1 is used to identify appropriate dimensions for the features described above (i.e., ridges, protrusions, and curved profiles) for reducing the contact time between an impinging droplet and a surface. For example, referring to Table 1, if the intended application is rainproof products and the feature type is ridges, then appropriate feature dimensions (in mm) are 0.0001<Aᵣ and λᵣ≥0.0001. Likewise, if the intended application is gas turbine blades and the feature type is protrusions, then appropriate feature dimensions (in mm) are 0.00001<Aᵣ and λᵣ≥0.00002.

As indicated in Table 1, Aᵣ, Aₚ, or A_{c} may be greater than 0.00001 mm, and λᵣ, λₚ, or λ_{c} may be greater than or equal to about 0.00001 mm. In certain embodiments, Aᵣ, Aₚ, or A_{c} is greater than about 0.0001 mm, greater than about 0.001 mm, greater than about 0.01 mm, greater than about 0.1 mm, or greater than about 1 mm. In certain embodiments, Aᵣ, Aₚ, or A_{c} is from about 0.00001 mm to about 0.001 mm, from about 0.0001 mm to about 0.01 mm, from about 0.001 mm to about 0.1 mm, or from about 0.01 mm to about 1 mm. In certain embodiments, λᵣ, λₚ, or λ_{c} is greater than about 0.0001 mm, greater than about 0.001 mm, greater than about 0.01 mm, greater than about 0.1 mm, or greater than about 1 mm. In certain embodiments, λᵣ, λₚ, or λ_{c} is from about 0.00001 mm to about 0.001 mm, from about 0.0001 mm to about 0.01 mm, from about 0.001 mm to about 0.1 mm, or from about 0.01 mm to about 1 mm.

TABLE 1
Ranges for droplet radius and macro-scale feature dimensions.

| | Droplet | Impact | Lamella | | Feature |
|---|---|---|---|---|---|
| | Radius, R | Velocity, V | Thickness, | Feature | Dimensions* |
| Application | (mm) | (m/s) | h (mm) | Type | (mm) |
| Rainproof | 0.1-5 | 0.5-20 | 0.01-1 | Type (i): | 0.0001 < Aᵣ, |
| products & | | | | ridges | λᵣ ≥ 0.0001 |
| wind turbine | | | | Type (ii): | 0.0001 < Aₚ, |
| | | | | protrusions | λₚ ≥ 0.0002 |
| | | | | Type (iii): | 0.0001 < A_{c}, |
| | | | | curvature | 0.0002 ≤ λ_{c} |
| Steam | 0.01-5 | 0.5-200 | 0.001-1 | Type (i): | 0.00001 < Aᵣ, |
| turbine | | | | ridges | λᵣ > 0.00001 |
| blades, | | | | Type (ii): | 0.00001 < Aₚ, |
| Aircraft | | | | protrusions | λₚ ≥ 0.00002 |
| icing, Gas | | | | Type (iii): | 0.00001 < A_{c}, |
| turbine | | | | curvature | 0.00002 ≤ λ_{c} |
| blades | | | | | |

In alternative embodiments, the devices and methods described herein apply to droplets of oil-based liquids impinging on an oleophobic surface or a superoleophobic surface. In this case, the macro-scale features, such as ridges, protrusions, and sinusoidal patterns, may produce oil droplet impingement dynamics that are similar to those shown and described for water droplets impinging a hydrophobic or superhydrophobic surface.

In certain embodiments, when a water droplet impinges a surface that is hot enough to vaporize the liquid quickly and generate sufficient pressure, the droplet can spread and rebound without ever touching the surface, mimicking a situation seen in superhydrophobic surfaces. This so-called Leidenfrost phenomenon is an example of a non-wetting situation without the surface being superhydrophobic. In one embodiment, the macro-scale features applied to this type of surface are effective in reducing the contact time of an impinging droplet. Specifically, the droplet dynamics are similar to those described above for the superhydrophobic surfaces, and the contact time reduction is of similar magnitude (˜50% of the theoretical limit). In one embodiment, to achieve the desired non-wetting behavior, the surface is heated to a temperature greater than the Leidenfrost temperature.

Various non-limiting examples of the arrangement of the macro features on the surface are presented below. The presence of the macro features on the surface facilitates asymmetric recoil of the impinging phase (e.g., droplets) from the surface. In some embodiments, the presence of the macro features on the surface facilitates asymmetric recoil of a higher proportion of the impinging phase (e.g., droplets from the surface per unit area of the surface. In some embodiments, the presence of the macro features presented below further reduces the contact time between the impinging phase (e.g., droplets) and the underlying surface.

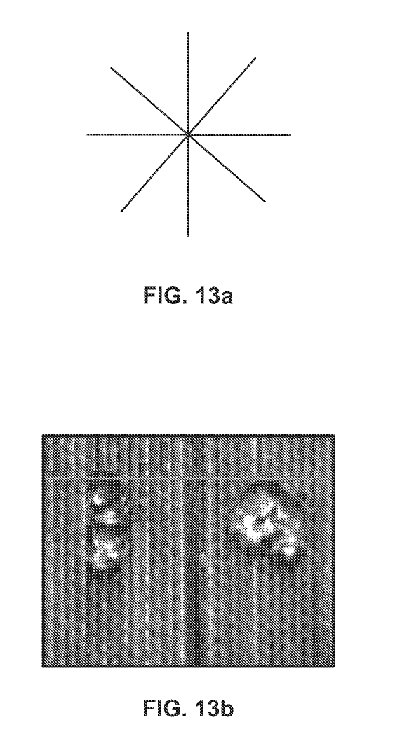

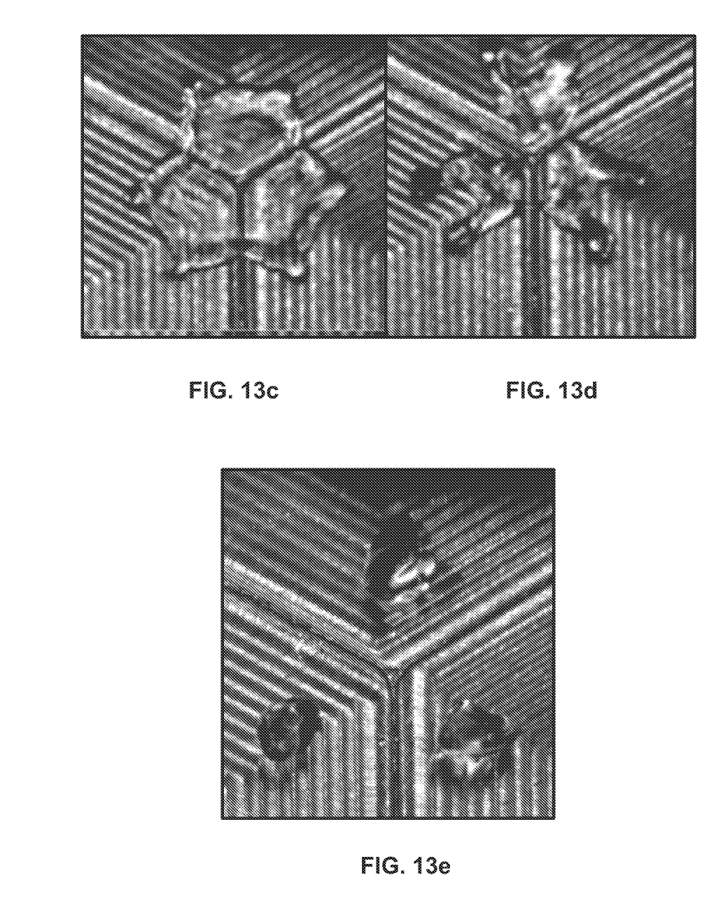

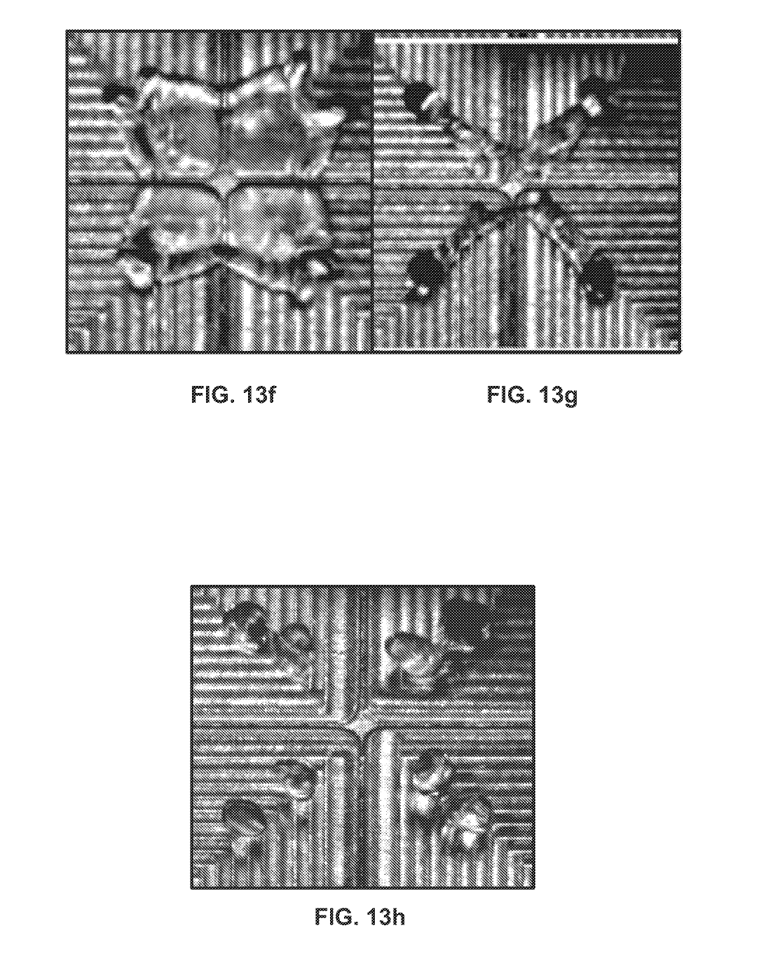

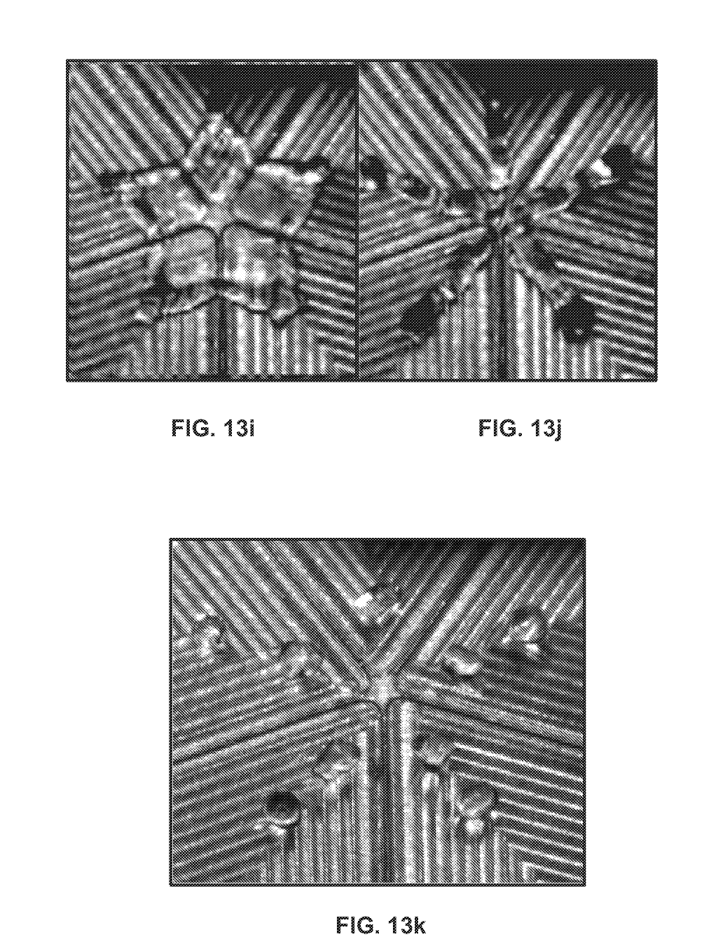

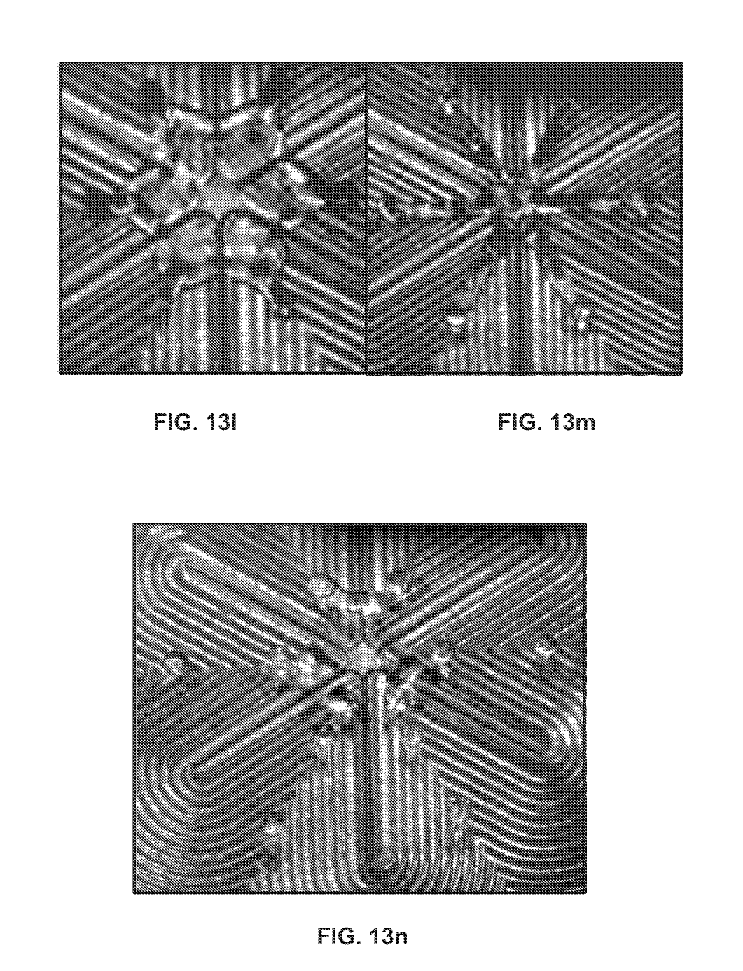

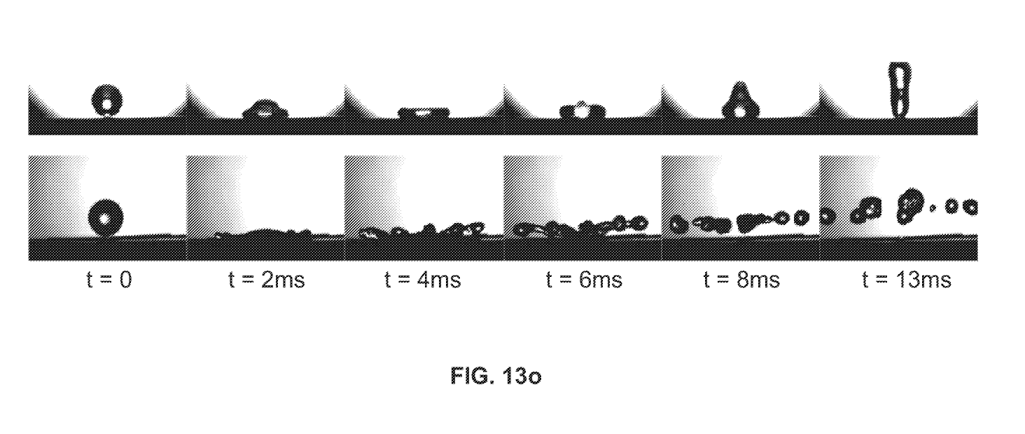

In some embodiments, stand-alone macro features (such as those shown in FIG. 8) are made of intersecting ridges, as shown in FIG. 13a. The angle α between the ridges and the number of ridges n are related as α=η/2(n−1). The minimum length of the ridges is equal to or approximately equal to 0.5 Dₘₐₓ (as discussed above in relation to FIG. 12c). In some embodiments, the number of ridges is n<20. In some embodiments, the number of ridges is 15 or less, 10 or less, 5 or less, or 3 or less. In some embodiments, all the ridges have the same length. In some embodiments, the ridges have varying lengths. The spacing between the features follows what is described above for the macro features of FIG. 8, i.e., λₚ. In some embodiments, the stand-alone features shown in FIG. 13a are arranged in the same way as shown in and discussed with regard to FIG. 8. In some embodiments, the stand-alone features shown in FIG. 13a are arranged in a random manner on the surface. In some embodiments, the non-wetting features are chosen so that θ_{d} is greater than 90 degrees and CAH is less than about 30 degrees, less than about 20 degrees, or less than about 10 degrees.

In some embodiments, when a droplet impinges on a stand-alone feature shown in FIG. 13a, the droplet spreads and forms a film on the stand-alone feature of FIG. 13a. The thickness of the film is thinnest at the locations where the film is in contact with the stand-alone feature of FIG. 13a, thereby causing the film to split across the intersecting ridges of the stand-alone feature of FIG. 13a and break into multiple drops. In some embodiments, this results in a reduced contact time between the droplet and the surface (e.g., contact time significantly below the theoretical minimum of Eq. 1 above). In addition, in some embodiments, as shown in FIG. 13a, the close proximity of the intersecting ridges to one another helps facilitate asymmetric recoil of a higher proportion of droplets (or another phase) impinging on the surface per unit area of the surface.

FIGS. 13c-13e are photographs of a water droplet impinging and recoiling off an aluminum surface heated above its Leidenfrost temperature, where the surface includes a central point and three ridges (spokes) radiating from the central point, according to an illustrative embodiment of the invention. The surface of FIGS. 13c-13e was textured with a macro feature that included a central point (hub) from which the three ridges (spokes) originated. The features may be arranged on the surface as discussed in relation to FIG. 13a. The ridges have a height and width on the order of 100 μm. FIG. 13c is a photograph of the droplet when it impacts the surface and spreads into a film on the surface. As shown in FIG. 13c, the droplet spreads along the macro feature. As shown in FIG. 13d, the impinging droplet splits up into multiple droplets upon recoil from the surface. As shown in FIGS. 13c and 13d, the film spreads on the macro feature in three distinct directions, which corresponds to the orientation of the three ridges on the macro feature shown. As further shown in FIGS. 13d and 13e, each droplet—after splitting—travels in one of three separate directions, with the direction of each split up droplet corresponding to the orientation of the three ridges on the macro feature. As shown in FIG. 13e, the droplet recoils from the surface as three separate droplets. The orientation of the macro feature shown in FIGS. 13c-13e facilitates droplet recoil from the surface and results in a contact time that is less than the theoretical contact time.

In some embodiments, e.g., as shown in FIGS. 13c-13d, the macro feature includes a central point (hub) from which three or more separate ridges originate (e.g., four or more, five or more, six or more, seven or more, etc.). In some embodiments, the ridges form one or more angles. In some embodiments, at least one of the one or more angles between the ridges may have any value between less than 1° to more than 180°. In some embodiments, the ridges form one or more angles. In some embodiments, at least one of the one or more angles between the ridges is between about than 5° and about 90°. In some embodiments, at least one of the one or more angles between the ridges is a right angle (i.e., 90°). In some embodiments, at least one of the one or more angles between the ridges is acute (i.e., less than 90°). In some embodiments, at least one of the one or more angles between the ridges is obtuse (i.e., an angle that is greater than 90° but less than 180°). In some embodiments, at least one of the one or more angles between the ridges is a reflex angle (i.e., an angle greater than 180°).

FIGS. 13f-13h are photographs of a droplet impinging and recoiling off an aluminum surface heated above its Leidenfrost temperature, where the surface includes two intersecting ridges (spokes), according to an illustrative embodiment of the invention. The macro features of FIGS. 13f-13h may be arranged on the surface as discussed in relation to FIG. 13a. The ridges have a height and width on the order of 100 μm. FIG. 13f is a photograph of the droplet when it impacts the surface and spreads into a film on the surface. As shown in FIG. 13f, the droplet spreads along the macro feature. As shown in FIGS. 13g-13h, the impinging droplet splits up into multiple droplets upon recoil from the surface. As shown in FIGS. 13f and 13g, the film spreads on the macro feature in four distinct directions, which corresponds to the orientation of the two intersecting ridges on the macro feature shown. As further shown in FIGS. 13g and 13h, each droplet—after splitting—travels in one of four separate directions, with the direction of each split up droplet corresponding to the orientation of the two intersecting ridges on the macro feature. As shown in FIG. 13e, the droplet recoils from the surface as eight separate droplets. The orientation of the macro feature shown in FIGS. 13f-13h facilitates droplet recoil from the surface and results in a contact time that is less than the theoretical contact time.

FIGS. 13i-13k are photographs of a droplet impinging and recoiling off an aluminum surface heated above its Leidenfrost temperature, where the surface includes a central point and five ridges (spokes) radiating from the central point, according to an illustrative embodiment of the invention. The features may be arranged on the surface as discussed in relation to FIG. 13a. The ridges have a height and width on the order of 100 μm. FIG. 13i is a photograph of the droplet when it impacts the surface and spreads into a film on the surface. As shown in FIG. 13i, the droplet spreads along the macro feature. As shown in FIGS. 13j-13k, the impinging droplet splits up into multiple droplets upon recoil from the surface. As shown in FIGS. 13i and 13j, the film spreads on the macro feature in five distinct directions, which corresponds to the orientation of the five ridges on the macro feature shown. As further shown in FIGS. 13j and 13k, each droplet—after splitting—travels in one of five separate directions, with the direction of each split up droplet corresponding to the orientation of the five ridges on the macro feature. As shown in FIG. 13k, the droplet recoils from the surface as about 10 separate droplets. The orientation of the macro feature shown in FIGS. 13i-13k facilitates droplet recoil from the surface and results in a contact time that is less than the theoretical contact time.

FIGS. 13l-13n are photographs of a droplet impinging and recoiling off an aluminum surface heated above its Leidenfrost temperature, where the surface includes a central point and six ridges (spokes) radiating from the central point, according to an illustrative embodiment of the invention. The features may be arranged on the surface as discussed in relation to FIG. 13a. The ridges have a height and width on the order of 100 μm. FIG. 13l is a photograph of the droplet when it impacts the surface and spreads into a film on the surface. As shown in FIG. 13m, the droplet spreads along the macro feature. As shown in FIGS. 13m-13n, the impinging droplet splits up into multiple droplets upon recoil from the surface. As shown in FIGS. 13l and 13m, the film spreads on the macro feature in six distinct directions, which corresponds to the orientation of the six ridges on the macro feature shown. As further shown in FIGS. 13m and 13n, each droplet—after splitting—travels in one of six separate directions, with the direction of each split up droplet corresponding to the orientation of the six ridges on the macro feature. As shown in FIG. 13n, the droplet recoils from the surface as multiple, 12 or more, droplets. The orientation of the macro feature shown in FIGS. 13l-13n facilitates droplet recoil from the surface and results in a contact time that is less than the theoretical contact time. The dimensionless contact time for the surface and set-up shown in FIGS. 13l-13n was calculated to be about 1.17, which is about 30% lower than the surface which included a micro ridge, shown in FIG. 13b (with dimensionless contact time being around 1.7).

FIG. 13o is a series of images of a water droplet bouncing off an aluminum plate heated above its Leidenfrost temperature. FIG. 13o (left) shows a droplet bouncing off the surface when the surface is flat (without any ridges); the contact time for this surface was slightly greater than 13 ms. FIG. 13o (right) shows a droplet impacting the center of 5 spokes, shown in FIGS. 13i-13k. When the drop impacts the center of 5 spokes, the droplet spreads and breaks up into several smaller droplets, which leave the surface in less than 8 ms, which is less than the theoretical minimum contact time provided in Equation 1.

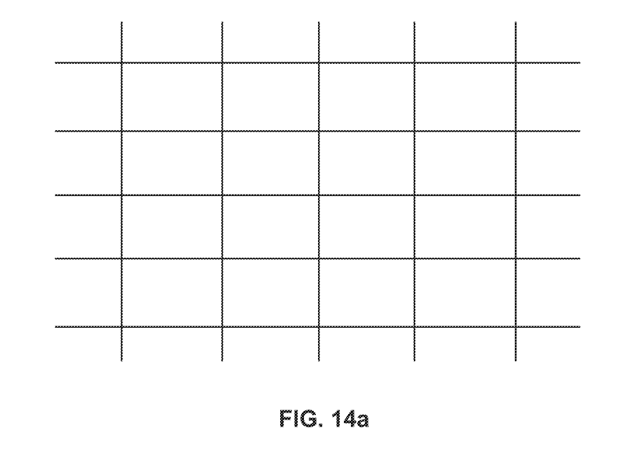

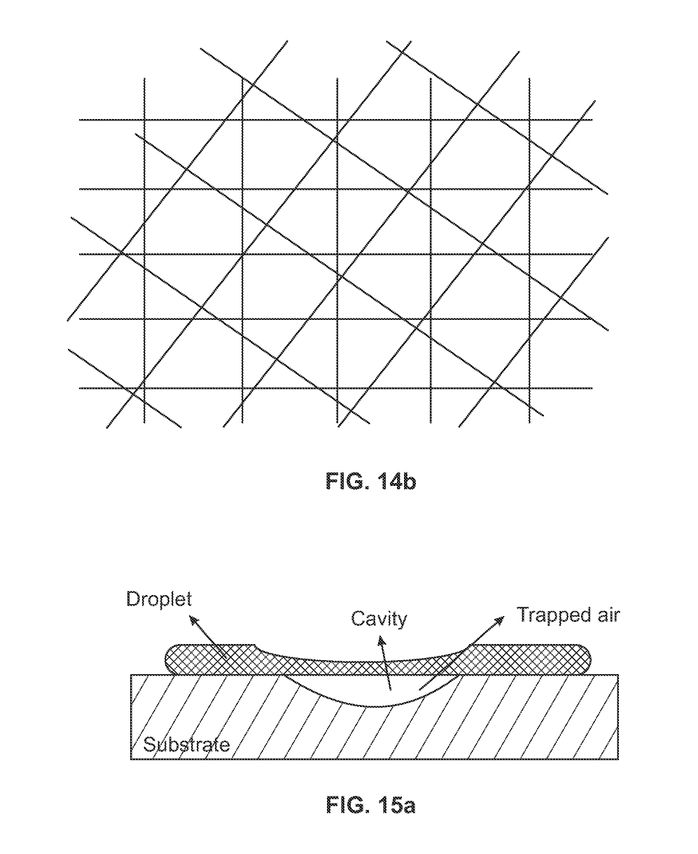

In some embodiments, the macro features are or include intersecting ridges or grooves, e.g., as shown in FIGS. 14a and 14b. In some embodiments, the intersecting ridges or grooves can be groups of parallel ridges or grooves extending throughout the surface. In certain embodiments, the distance between the parallel lines is given by the specifications on λᵣ. In certain embodiments, the angle of intersection between the parallel lines is set by α=η/2(n−1). Furthermore, ridge edges can be designed to facilitate drop ejection from the surface (e.g., as shown in and discussed with regard to FIG. 11b).

In some embodiments, when a droplet impinges on a stand-alone feature shown in FIG. 14a or 14b, the droplet adopts the profile of the feature that it contacts, and the film spreads on the feature that it contacts (e.g., the particular profile of the film formed by the impinging droplet depends on where on the feature the droplet impinges). The thickness of the film is thinnest at the locations where the film is in contact with the feature (e.g., ridge, groove), thereby causing the film to split across the ridges and grooves of FIGS. 14a and 14b and break into multiple drops. In some embodiments, this results in a reduced contact time between the droplet and the surface (e.g., contact time significantly below the theoretical minimum of Eq. 1 above). In addition, in some embodiments, as shown in FIGS. 14a, and 14b, the close proximity of the intersecting ridges to one another helps facilitate asymmetric recoil of a higher proportion of droplets (or another phase) impinging on the surface per unit area of the surface.

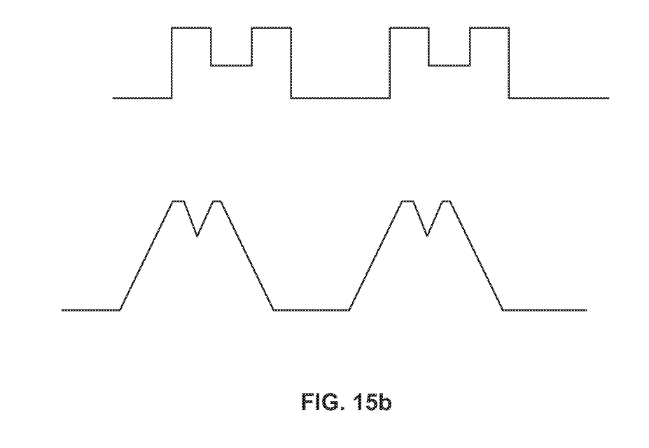

In some embodiments, the macro features are depressions, for example, as shown in FIG. 15a. In some embodiments, the depressions trap air, as shown in FIG. 15a. In some embodiments, the macro features are or include depressions that do not trap air. In some embodiments, the macro features can be cavities that are discrete or that form channels (e.g., as shown in FIG. 15a). In some embodiments, the macro features can be hybrid projections and cavities (as shown in FIG. 15b). The spacing between the hybrid projections is similar to the scale of the projections. In some embodiments, the spacing between the projections is proportional to the height of the projections, the width of the projections, or the depth of the depressions formed within the projections). In some embodiments, the length of the spacing between the projections is equal to 40-100% of the height or the width of the projections. In some embodiments, the features can trap gas (e.g., air) to enhance the droplet repellency effect. In some embodiments, e.g., as shown in FIG. 15a, the droplet spreads on the depression without assuming the shape of the depression, e.g., with the droplet sitting atop the depression. The trapped air facilitates the droplet recoil from the surface. In some embodiments, the trapped air, shown in FIG. 15a, acts as a spring in facilitating the droplet recoil.

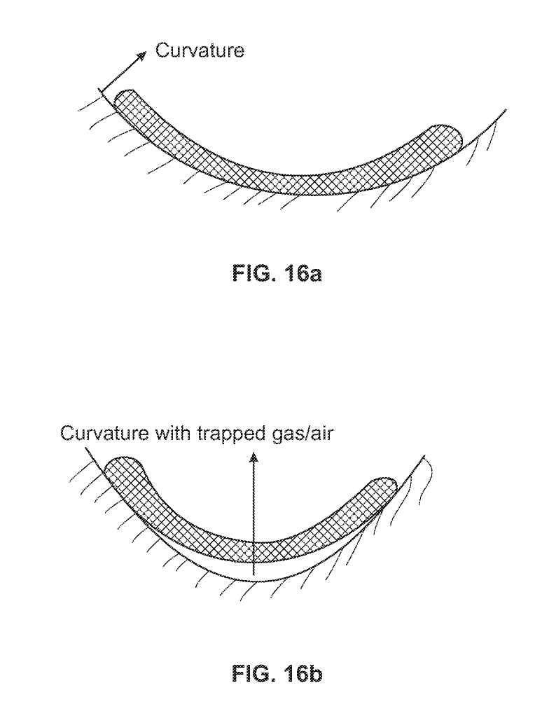

In some embodiments, the macro features can have curvature, including convex curvature (e.g., as shown FIG. 3d) or concave curvature, without trapped gas/air (FIG. 16a) or with trapped gas/air (FIG. 16b).

Referring to FIG. 16a, in some embodiments, an impinging droplet adopts the curved profile of the surface while spreading and becomes a thin film of varying thickness. The curvature of the surface of FIG. 16a facilitates droplet recoil from the surface. Referring to FIG. 16b, in some embodiments, an impinging droplet adopts the curved profile of the surface while spreading, but sits atop trapped air, and the droplet becomes a thin film of varying thickness atop the trapped air. The curvature of the macro features of FIG. 16b and the trapped air within the macro features help facilitate droplet recoil from the surface. In addition, the curvature of the macro features of FIG. 16b and the trapped air within the macro features help reduce the contact time of the impinging droplet.

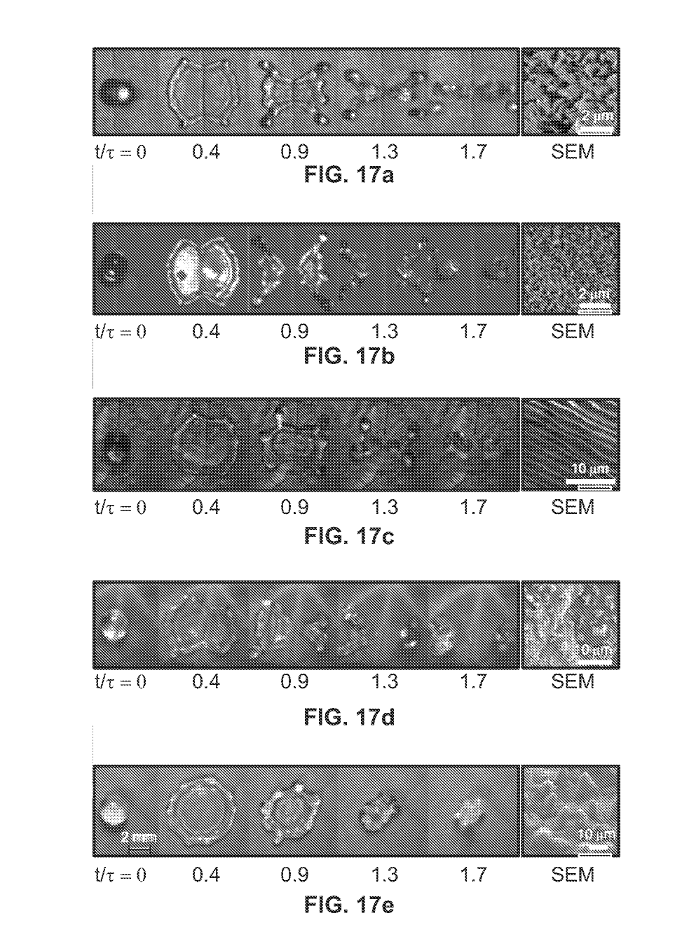

Referring now to FIGS. 17a, 17b, 18, and 19, similar macrotextures (to those discussed above in relation to FIGS. 5d and 5f) in aluminum and copper were fabricated by milling ridges, followed by microtexturing and coating with fluorosilane. As shown in FIGS. 17a, 17b, 18, and 19, the recoil dynamics were similar to those obtained on the macrotextured laser-ablated silicon surface (FIGS. 5d, 5f).

Previous experiments indicate that the drop contact time t_{c} is independent of the dimensionless Webernumber, We(≡ρU²R/γ); and indicate that the contact time t_{c} scales with the inertial-capillary timescale, r≡\sqrt{ρR³/γ}. The contact times relative to T are included herein. The minimum contact time for low-deformation impact (We>1) can be approximated by the lowest-order oscillation period for a spherical drop, t_{c}/τ=π/\sqrt{2}≈2.2. For large-deformation impact (We>1), the contact time is similar even though the dynamics are distinctly different. Indeed, past experiments documenting a drop bouncing on a passive surface—including Leidenfrost drops—have reported a contact time greater than tₒ/τ=2.2 (as shown in Table 2), which translates to between 12 and 13 ms in the experiment examples.

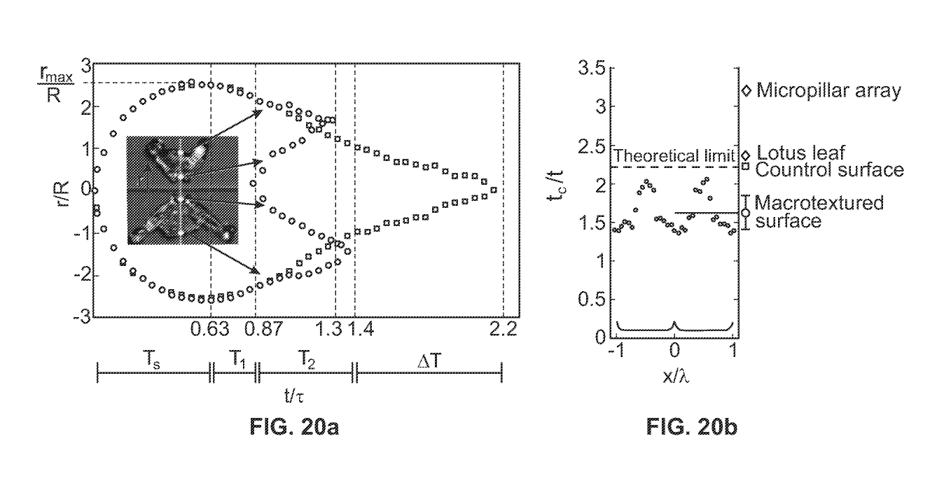

TABLE 2
Experimental contact time of bouncing drops from past studies
The dynamics for a macrotextured surface are more complex. The drop
initially spreads over a time Tₛ = 0.63 and then begins to recoil
(black filled circles in FIG. 20a). During the next time interval T₁,
the film recoils along the ridge faster than it recoils perpendicular to the
ridge, splitting into two drop fragments (e.g., as shown FIG. 5d). At this
point, the outer rim of the initial drop continues to recoil inward while the newly

| | | Radius | Contact | Contact time |
|---|---|---|---|---|
| Study | Droplet | (mm) | time (ms) | (dimensionless) |
| Wachters & Westerling | Water on | 1.15 | 11.1 | 2.4 |
| (1966)¹ | hot solid | | | |
| Richard & Quere (2000)² | Water | 0.4 | 2.6 | 3 |
| Aziz & Chandra (2000)³ | Molten | 1.35 | 13 | 2.3 |
| | tin | | | |
| Richard et al. (2002)⁴ | Water | 0.1-5 | 0.3-50 | 2.6 |
| Clanet et al. (2004)⁵ | Water | 1.25 | 13.5 | 2.6 |
| Bartolo et al. (2005)⁶ | Water | 1 | 16 | 4 |
| Legendre et al. (2005)⁷ | Toluene | 1.3 | 28 | 3 |
| | in water | | | |
| Bartolo et al. (2006)⁸ | Water | 1 | 15 | 4 |
| Reyssat et al. (2006)⁹ | Water | 1.2 | 13 ± 2 | 3 |
| Jung &Bhushan (2008)¹⁰ | Water | 1 | 16 | 4 |
| Brunet et al. (2008)¹¹ | Water | 1.35 | 23 | 4 |
| Tuteja et al. (2008)¹² | Hexadecane | 0.72 | 350 | 110 |
| Tsai et al. (2009)¹³ | Water | 1 | 12.5 | 3 |
| Reyssat et al. (2010)¹⁴ | Water | 1.15 | 13 | 2.8 |
| Mishchenko et al. (2010)¹⁵ | Water | 1.5 | 20 | 2.9 |
| Li et al. (2010)¹⁶ | Water | 1.35 | 14.9-22.3 | 2.5-3.8 |
| Zou et al. (2011)¹⁷ | Water on | 0.86-2.33 | 15-62 | 4.8^{§} |
| | water | | | |
| Kwon & Lee (2012)¹⁸ | Water | 0.022 | 0.032 | 2.6 |
| This application | Water | 1.3 | 7.8 | 1.4 |

¹Wachters, L. H. J. & Westerling, N. A. J. The heat transfer from a hot wall to impinging water drops in the spheroidal state. Chem. Eng. Sci. 21, 1047-1056 (1966).
²Richard, D.&Quere, D. Bouncing water drops. Europhys. Lett. 50, 769-775 (2000).
³Aziz, S. D.& Chandra, S. Impact, recoil, and splashing of molten metal droplets. Int. J. Heat Mass Transfer 43, 2841-2857 (2000).
⁴Richard, D., Clanet, C. & Quere, D. Contact time of a bouncing drop. Nature 417, 811 (2002).
⁵Clanet, C., Beguin, C., Richard, D.& Quere, D. Maximal deformation of an impacting drop. J. Fluid Mech. 517, 199-208 (2004).
⁶Bartolo, D., Josserand, C. & Bonn, D. Retraction dynamics of aqueous drops upon impact on non-wetting surfaces. J. Fluid Mech. 545, 329-338 (2005).
⁷Legendre, D., Daniel, C. & Guiraud, P. Experimental study of a drop bouncing on a wall in a liquid. Phys. Fluids 17, 097105 (2005).
⁸Bartolo, D. et al. Bouncing or sticky droplets: impalement transitions on superhydrophobic micropatterned surfaces. Europhys. Lett. 74, 299-305 (2006).
⁹Reyssat, M., Pepin, A., Marty, F., Chen, Y. & Quere, D. Bouncing transitions on microtextured materials. Europhys. Lett. 74, 306 (2006).
¹⁰Jung, Y. C. & Bhushan, B. Dynamic effects of bouncing water droplets on superhydrophobic surfaces. Langmuir 24, 6262-6269 (2008).
¹¹Brunet, P., Lapierre, F., Thomy, V., Coffinier, Y. & Boukherroub, R. Extreme resistance of superhydrophobic surfaces to impalement: reversible electrowetting related to the impacting/bouncing drop test. Langmuir 24, 11203-11208 (2008).
¹²Tuteja, A., Choi, W., Mabry, J., McKinley, G. H. & Cohen, R. E. Robust omniphobic surfaces. Proc. Natl Acad. Sci. USA 105, 18200-18205 (2008).
¹³Tsai, P., Pacheco, S., Pirat, C., Lefferts, L. & Lohse, D. Drop impact upon micro- and nanostructured superhydrophobic surfaces. Langmuir 25, 12293-12298 (2009).
¹⁴Reyssat, M., Richard, D., Clanet, C. & Quere, D. Dynamical superhydrophobicity. Faraday Discuss. 146, 19-33 (2010).
¹⁵Mishchenko, L. et al. Design of ice-free nanostructured surfaces based on repulsion of impacting water droplets. ACS Nano 4, 7699-7707 (2010).
¹⁶Li, X. Y., Ma, X. H. & Lan, Z. Dynamic behavior of the water droplet impact on a textured hydrophobic/superhydrophobic surface: the effect of the remaining liquid film arising on the pillars' tops on the contact time. Langmuir 26, 4831-4838 (2010)
¹⁷Zou, J., Wang, P. F., Zhang, T. R., Fu, X. & Ruan, X. Experimental study of a drop bouncing on a liquid surface. Phys. Fluids 23, 044101 (2011).
¹⁸Kwon, D. H. & Lee, S. J. Impact and wetting behaviors of impinging microdroplets on superhydrophobic textured surfaces. Appl. Phys. Lett. 100, 171601 (2012).

formed inward rim recoils outward. This combined inward and outward recoil continues over the time interval T₂. At dimensionless time t/τ=1.3, one of the fragments lifts off the surface and at t/τ=1.4, the remaining fragment lifts off. The difference in contact time on the two surfaces is denoted as ΔT.

This reduction, ΔT, may not be rationalized by modifying the radius in the theoretical scaling to reduce the drop volume by half. This approach is not physically appropriate because the drop splits after it has spread out (as shown in FIG. 5d). Therefore, the film thickness depends on the initial droplet radius, as opposed to the reduced radius.

One approach is to estimate ΔT using a hydrodynamic model that combines thin film retraction, conservation of mass, and variations in film thickness due to the macrotexture. First, the axisymmetric dimensionless retraction time on the control surface is expressed as Tᵣ=T₁+T₂+ΔT=rₘₐₓ/Vτ, where rₘₐₓ is the maximum wetting radius and V is the average retraction velocity. Next, the ridge dewetting time is estimated as T₁≈rₘₐₓ/(Vₚτ) where Vₚ is the retraction velocity along the peak of the macrotexture. The interval over which the fragmented drops retract is approximated as T₂≈(rₘₐₓ−VT₁τ)/(2Vτ). The velocities of the outward rim and the newly-formed inward rim are assumed to be equal to each other and to the velocity of the axisymmetric control film. Thus, the thin-film retraction speed away from the ridge is approximately V≈\sqrt{2γ/(ρh)}, and the speed on the macrotexture peak is Vₚ≈\sqrt{(2γ)}/[ρ(h−a)], where a is the macrotexture amplitude. After noting that mass conservation requires (4/3)πR³ρ≈πrₘₐₓ²hρ, the previous expressions combine to reveal that

$$Δ T \approx \frac{\sqrt{6}}{6} ( 1 - \sqrt{1 - \frac{1}{h}} ) .$$

If there is no macrotexture (a=0), then there is no contact time reduction (ΔT=0). If the macrotexure amplitude is equal to or greater than the film thickness (a=h), then the hydrodynamic model predicts a contact time reduction of Δt_{c}≈0.4τ.

As FIGS. 20A and 20b reveal, the model provides the correct order of magnitude, but underestimates the actual experimentally observed reduction by a factor of ˜2. This difference is due to assumptions that are visible in FIGS. 20a and 20b. First, the retraction velocity is slower than predicted when the thin-film assumption breaks down. Second, the velocities of the inner and outer fronts are different, because the film thickness is not uniform. Last, the film away from the ridge spreads out further than the film on the ridge (FIG. 5d), resulting in an over-prediction of T₁ and under-prediction of ΔT. Nevertheless, the model elucidates the mechanism that reduces the overall contact time.

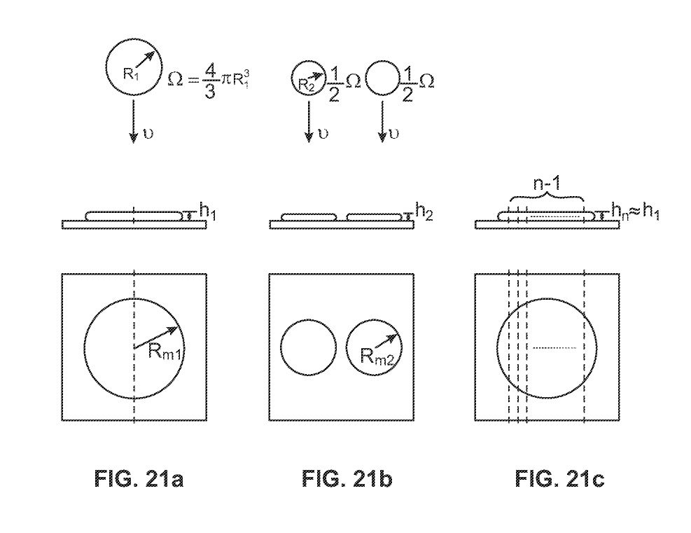

Careful inspection of FIG. 20a reveals that the two fragments leave the surface at slightly different times because the drop impacts the ridge slightly off-centre. At larger deviations from the ridge, this difference between the fragment lift-off times is more pronounced, increasing the overall contact time. The dimensionless contact times t_{c}/τ are reported for various landing locations along the periodic macrotexture x/λ (FIG. 20b). The contact time is shortest when the drop impacts directly on the ridge, increasing as the drop lands further away from the ridge, and then decreasing as the drop approaches the next ridge. The mean contact time over the entire surface was t_{c}/τ=1.6 with standard deviation σ=0.2, a time significantly shorter than that on the control surface (FIG. 20b). For comparison, a drop under identical conditions contacted a lotus leaf for t_{c}/τ=2.3 and a micropillar array for t_{c}/τ=3.2 (FIG. 21b).

The contact time cannot be predicted correctly with the current theoretical scaling, though the radius is substituted with one of each split part. Simplistically considering the ridge case equivalent to that of two drops impinging with volumes equal to those of split parts results in an incorrect estimation of the contact time. FIGS. 21a-21b explain the two scenarios: the ridge case (FIG. 21a) and the simplistic case (two droplets of FIG. 21b). While the drop in the former case splits on the surface while retracting (subscript 1), the latter case is split before impact (subscript 2). If the initial drop volume,

$$Ω = \frac{4}{3} π {R}_{1}^{3} ,$$

is split into two equal parts, the radius of the split part is

$${R}_{2} = {R}_{1} / \sqrt[3]{2} .$$

The simplistic approach therefore suggests that the contact time would be calculated as

$${t}_{c} = 2.2 \sqrt{\frac{ρ}{γ} {( \frac{{R}_{1}}{\sqrt[3]{2}} )}^{3}} \qquad ( 7 )$$

and thereby

$$\frac{{t}_{c}}{τ} = \frac{2.2}{\sqrt{2}} = 1.6 .$$

This value is close to the measured value of 1.4. Notwithstanding, by considering the retraction time in both cases, it was shown that splitting on the surface and splitting before impact are two fundamentally different scenarios that lead to very different contact times. The retraction time scales as t_{c}˜Rₛ/V_{T-C}, where R_{d} is the distance the film needs to travel to dewet and V_{T-C} is the Taylor-Culick retraction velocity. Substituting in the velocity, this time can be rewritten as:

$${t}_{r} ∼ \frac{{R}_{d}}{\sqrt{2 γ / ρ h}} , \qquad ( 8 )$$

where h is the average thickness of the liquid film when retraction begins. The thickness h can be expressed in terms of the radius of the initial drop R and the maximum radius of the spread film Rₘ by considering the conservation of droplet mass before impact and at the instant of maximum spread: Rₘ²h˜R³. Combining these expressions and noting that

$${R}_{2} = {R}_{1} / \sqrt[3]{2} ,$$

it was found that the times for the two cases are different, highlighting that a nonaxisymmetric drop split on the surface has a different contact time than two axisymmetric drops split before contacting the surface:

$${t}_{r , 1} ∼ \frac{{R}_{m 1} / 2}{\sqrt{2 γ / ρ {h}_{1}}} = \frac{1}{2} \frac{{R}_{1}^{3 / 2}}{\sqrt{2 γ / ρ}} \neq {t}_{r , 2} ∼ \frac{1}{\sqrt{2}} \frac{{R}_{1}^{3 / 2}}{\sqrt{2 γ / ρ}} \qquad ( 9 )$$

In general, if the spread out drop is split into n films of almost equal thickness (FIG. 21c), then

$${h}_{n} \approx {h}_{1} , {t}_{r , 1} ∼ \frac{1}{n} \frac{{R}_{1}^{3 / 2}}{\sqrt{2 γ / ρ}} \qquad ( 10 )$$

whereas in the case of FIG. 21c for n equal volume drops,

$${t}_{r , 2} ∼ \frac{1}{\sqrt{n}} \frac{{R}_{1}^{3 / 2}}{\sqrt{2 γ / ρ}} \qquad ( 11 )$$

Equations (10) and (11) show that the retraction time for the drops split prior to axisymmetric impact scales as

$$t ∼ \frac{1}{\sqrt{n}} ,$$

whereas for the ridge case (when the film splits on the surface) the retraction time scales as

$$t ∼ \frac{1}{n} .$$

The difference in scaling again demonstrates that these two cases are fundamentally different. Furthermore, the exact form of scaling could be affected due to non-trivial effects, such as Rayleigh-Plateau instabilities, zipping (FIG. 5e), and complex geometries (FIG. 2d).

Ice build-up from freezing rain is problematic for a variety of applications including aircraft surfaces, wind turbines, and power lines. If a water drop were to bounce off a surface before it were to freeze, then ice build-up can be significantly reduced. When a liquid droplet impinges a solid surface that is kept below its freezing point, spreading and solidification of the droplet occur simultaneously. Whether a drop bounces or gets arrested on the surface depends on the extent of solidification, which in turn, depends on the contact time for a given set of temperatures and thermophysical properties of the droplet and substrate materials.

Blades of steam and gas turbines are sometimes fouled by metallic fragments that are produced due to erosion/corrosion of intermediary equipment in the power cycle. These fragments are carried along with the working fluid (steam or combustion gases, as the case may be) and melt when they reach regions of high temperatures. The melted liquid impinges upon turbine blades and gets stuck thereby deteriorating aerodynamic performance and hence turbine power output. Surface designs according to some embodiments discussed herein can solve this problem by rapidly repelling the impinging molten liquid before it can freeze on blade surfaces.

### Experimental Examples

As described herein, a series of experiments were conducted to measure and visualize the impingement of droplets on surfaces having macro-scale features. A high speed camera system (Model SA 1.1, PHOTRON USA, San Diego, Calif.) was utilized to capture a sequence of images of the droplet impingement. Droplets of controlled volume (10 μL) were dispensed using a syringe pump (HARVARD APPARATUS, Holliston, Mass.) using a 26 gauge stainless steel needle. Droplet impact velocity was controlled by setting the needle at a certain height (e.g., 150 mm) above the surface. Contact times were determined from the images by identifying the time difference between the point of initial droplet contact with the surface and the subsequent rebound of liquid from the surface.

Images of macro-scale ridges and droplets impinging on the ridges are provided in FIGS. 6a-6d and 7a-7c, in accordance with certain embodiments of the invention. FIGS. 6a-6d show photographs of droplet impingement on a ridge 600 fabricated on a silicon surface 602 using laser-rastering.

Control surfaces were fabricated by irradiating silicon surfaces with 100-ns pulses at a repetition rate of 20 kHz from an Nd:YAG laser at 1,064 nm wavelength and 150 W maximum continuous output. The surface was kept normal to the direction of the incident beam. Desired patterns were produced by rastering the laser beam with multiple steps. The surface was superhydrophobic with an advancing contact angle of 163° and a receding contact angle of approximately 161°. These surfaces (control) displayed minimal pinning, as indicated by the extremely low contact angle hysteresis, ˜2°. The ridge surface was designed such that the height varied as z=a sinⁿ(χ/λ), where x is the horizontal distance and a, n, and λ are constant parameters. The values of these parameters were selected as λ=4 mm (to allow the drop to interact with one or two peaks regardless of impact locations), a=150 μm (to provide a feature amplitude large enough to influence the film thickness h) and n=100 (to restrict the full-width at half-maximum of the texture to 300 μm, a value small enough not to significantly influence the film thickness h away from the peak).

### Anodized Aluminum Oxide (AAO) Experiments

FIGS. 7a-7c show droplet impingement on a ridge 700, of similar dimensions, to that discussed above, milled on an aluminum surface 702, followed by anodization to create nano-scale pores.

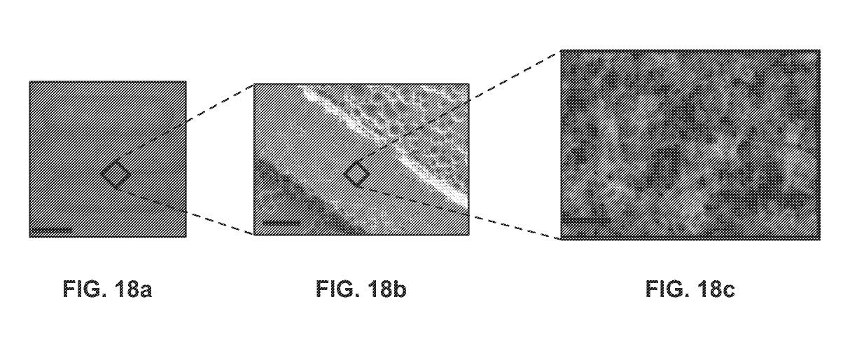

The anodized aluminum oxide (AAO) surface was prepared by a two-step anodization and etching process. A 40 mm×40 mm square and 5 mm thick piece of aluminum (grade 6061) was milled in a CNC machine to produce ridges of 100 mm height and 200 mm width, as shown in FIG. 18a. The surface was then thoroughly cleaned by first sonicating in acetone, followed by rinsing with ethanol and distilled water and drying with nitrogen. The surface was first electropolished with a mixture of perchloric acid and ethanol (in a ratio of 1:3, respectively) for 20 min at 20 V and 100 mA. During this process, the mixture was stirred and maintained at 7° C. with the help of a stirrer plate. The surface was then washed several times with distilled water and then dried using nitrogen. After electropolishing, the surface was anodized with phosphoric acid for one hour at 40 V while the acid was continuously stirred and maintained at 15° C. The surface was again thoroughly washed with distilled water and dried with nitrogen. The surface was then ready for etching, which was done with a mixture of chromic and phosphoric acids that were dissolved in distilled water in a proportion of 1.6 wt % and 6 wt %, respectively. The etching was done for 45 min while the mixture was maintained at 65° C. and continuously stirred. After this step, the surface was thoroughly washed with distilled water, dried with nitrogen, and kept overnight in a refrigerator. The etching step was repeated at the same conditions for 2 h. Finally, the surface was cleaned thoroughly with distilled water and dried with nitrogen. SEM images (FIGS. 18b-c) of the anodized surface reveal that it has a hierarchical structure including micropits (˜10-50 mm) and nanometre-scale pores (˜50-100 nm). A drop of water placed on the surface spread completely, indicating that the surface was superhydrophilic. To characterize the hydrophobicity, contact angles were measured with a goniometer and found to be about 159° (advancing) and 157° (receding), indicating the surface was superhydrophobic with minimal pinning.

Both surfaces 602, 702 were made superhydrophobic by depositing trichloro(1H,1H,2H,2H-perfluorooctyl)silane. The diameter of the droplet before impingement was 2.6 mm (i.e., R=1.3 mm) and the impact velocity was 1.8 m/s. As discussed in detail above, the contact times achieved with the macro-scale ridges were about 50% less than the theoretical prediction from Equation 1 (i.e., 13.5 ms) with ϕ=0.

Images of macro-scale protrusions and droplets impinging on the protrusions are provided in FIGS. 9a-9c, in accordance with certain embodiments of the invention. The surface 900 in this example is made of anodized titanium oxide (ATO). Details of the surface 900 are shown in the SEM images. The scale bars 904, 906 in FIGS. 9a and 9b are 100 μm and 4 μm, respectively. As depicted, the surface includes macro-scale protrusions 902, of about 20-100 μm, which further contain non-wetting features to maintain superhydrophobicity. As discussed in detail above, the contact times achieved with the macro-scale protrusions was about half of the theoretical prediction (i.e., 13.5 ms) from Equation 1 with 0=0.

Images of macro-scale curvature and droplets impinging on the curvature are provided in FIGS. 11a and 11b, in accordance with certain embodiments of the present invention. As discussed above, the sinusoidal curved surface 1100 was fabricated on silicon using laser rastering. The details of the surface 1100 are shown with the help of SEM images. The wave amplitude A_{c} of the sinusoidal pattern was about 350 μm while its period (i.e., twice the wave spacing λ_{c}) was 2 mm. The surface 1100 was made superhydrophobic by depositing trichloro(1H,1H,2H,2Hperfluorooctyl)silane. The contact time in this example was only about 6 ms, which is again well over 50% smaller than the theoretical prediction of Equation 1 (i.e., 13.5 ms).

### Silicon Micropillar Array Fabrication

The silicon micropillar array used in some of the experiments discussed herein was fabricated using standard photolithography processes. A photomask with square windows was used and the pattern was transferred to photoresist using ultraviolet light exposure. Next, reactive ion etching in inductively coupled plasma was used to etch the exposed areas to form micropillars (each micropillar was 10 μm square with 10 μm height and was separated from the next pillar by 5 μm). Trichloro(1H,1H,2H,2H-perfluorooctyl)silane was coated onto the micropillars using vapour-phase deposition to render the surface superhydrophobic (advancing contact angle, 165°, receding contact angle), 132°.

### Copper Substrate Experiment

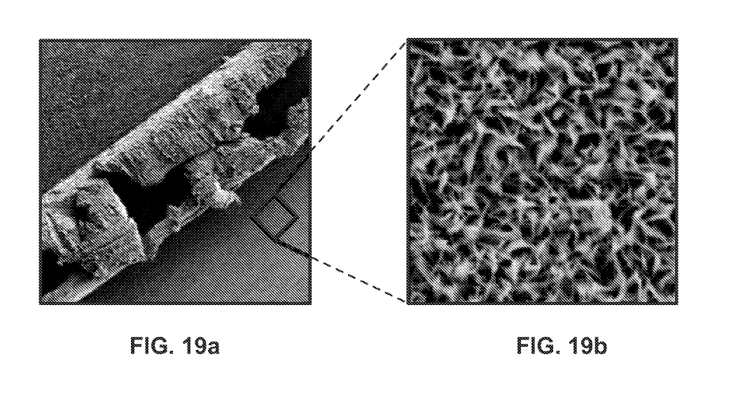

The 100 μm high and 200 μm wide ridges were milled on a copper block, as for the AAO surface discussed above. Then, spiky nanostructures were fabricated on the surface. The milled copper plate was ultrasonically cleaned in 3M hydrochloric acid for 10 min, and rinsed with deionized water. Then, the plate was treated in a 30 mM sodium hydroxide solution, kept at 60° C., for 20 h, followed by multiple rinses with deionized water and drying with nitrogen. The treated surface shows spike-like nano-scale textures, shown in FIG. 19. Then, the surface was coated with trichloro(1H,1H,2H,2H perfluorooctyl) silane using vapour-phase deposition to render it superhydrophobic.

### Tin Droplet Experiments

Liquid tin also was used in these experiments due to experimental constraints associated with the sub-cooling that could be achieved in certain embodiments. Liquid tin is a good model system for water since the timescales of bouncing and freezing are on the same order. Particularly, the bouncing timescale (t_{c}≈\sqrt{ρR³/γ}) for identical drop sizes are almost equal as the ratio of density to surface tension for liquid tin and water are very close. The drops bounce off of the macrotextured surface while they freeze on the surface without macrotextures.

For metal droplet impact experiments, the substrates were laser-ablated silicon, identical to the ones used for water droplet experiments described in FIGS. 5c-d. Liquid tin makes a large contact angle)(˜120° with smooth silicon and therefore is able to bounce off the microscopically textured surfaces. The key parameter varied in these experiments was the substrate temperature as it controlled the amount of solidification of the impacting tin droplet. Since molten tin oxidizes rapidly in air, the experiments were conducted in a glove box, which could maintain oxygen concentration below 150 ppm. Droplets of molten tin with radius 1.25 mm were produced using a drop-on-demand droplet generator. The droplet impact velocity was controlled by setting the height, above the substrate surface, from which droplets ejected out of the droplet generator and was about 1.3 m/s, identical to its value for the water droplet experiments. The temperature of the droplet was about 250° C., which is above the melting point of tin (232° C.). The substrate temperature was controlled by mounting it on a copper block (30 mm×20 mm×5 mm) having three cartridge heaters (5 W each) controlled via a temperature controller (CN 3112, Omega). A high thermal conductivity pad (Bergquist Gap Pad 1500) was inserted between the substrate and the copper block in order to minimize thermal contact resistance. A thermocouple kept below the thermal pad measured the substrate temperature while a high-speed camera captured droplet deformation during impingement on the substrate.

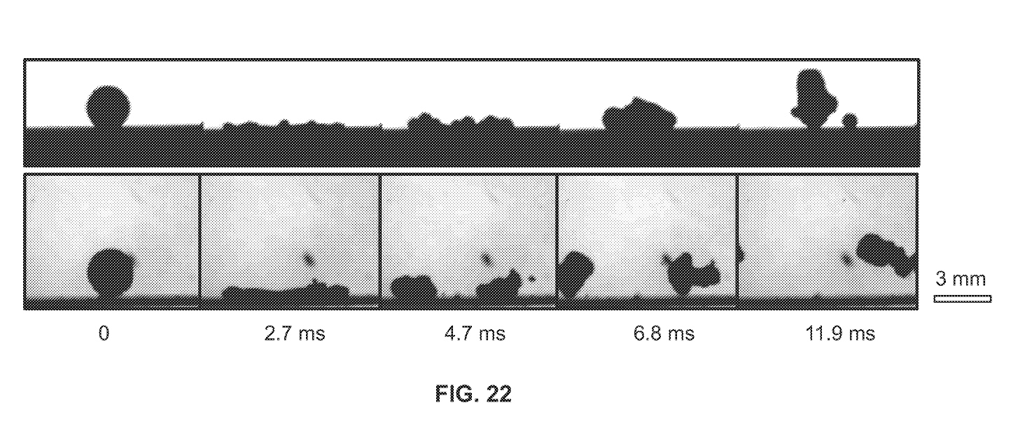

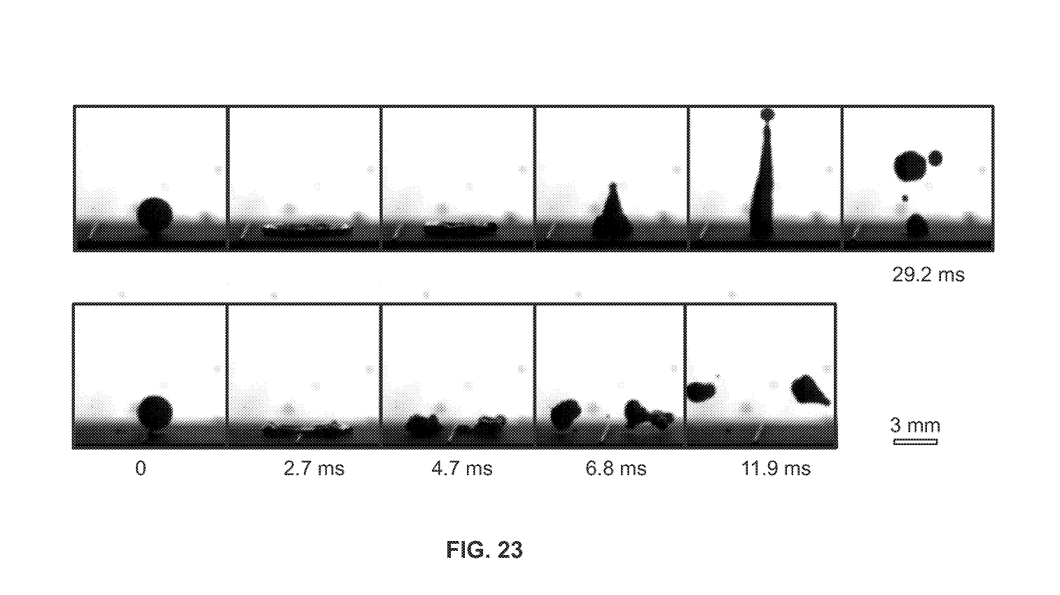

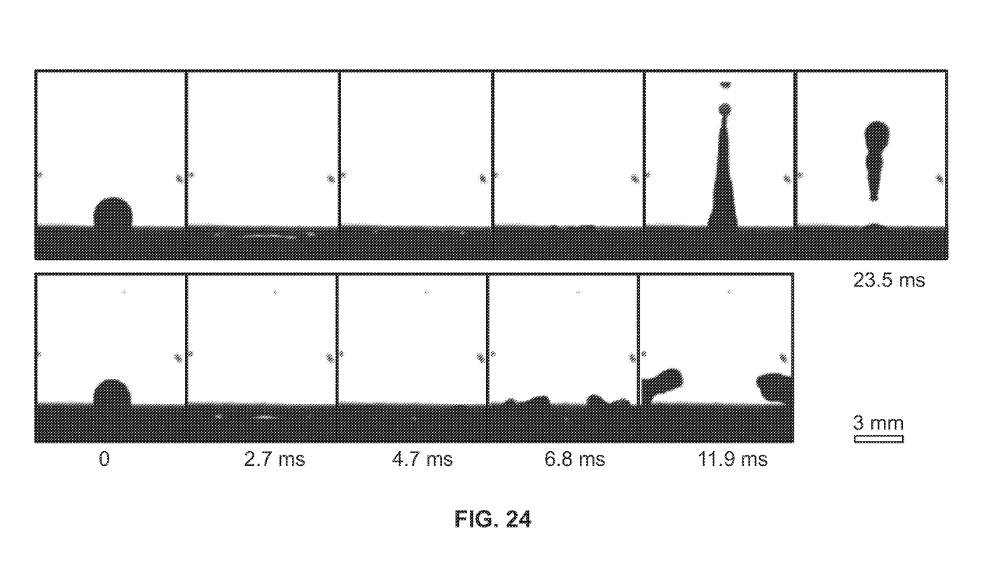

FIG. 22 shows tin droplets impacting silicon substrates without (top row of images) and with the macroscopic ridge (bottom row of images). In both cases, the droplets were able to bounce off of the substrate completely, however, the contact time when the droplet hit the substrate with the ridge was significantly less (6.8 ms) than that without the ridge (11.9 ms). This is consistent with the results of the experiments with water droplets discussed above. Droplets were observed to bounce off (but with different contact times) completely for both cases (with and without ridges) until the substrates were cooled to 125° C. (subcooling˜107° C.) when droplets impacting the substrate without the ridge got severely arrested (FIG. 23, top row) so that the contact time was infinite. However, droplets impacting the substrate with the macroscopic ridge continued to bounce-off (FIG. 23, bottom row,). Droplets impacting the ridge continued to bounce off until the substrate was cooled to about 50° C., indicating that a significantly large subcooling˜182° C. is needed to arrest the droplets on the ridge surface (FIG. 24, bottom row). These experiments demonstrate that the contact time reduction achieved according to some embodiments discussed herein by using designed macrostructures (ridges in this particular experiment) is significant enough to change the outcome of the droplet impact process over a large range of temperatures.

The liquid tin experiments provide evidence that reducing drop contact time reduces the total heat transferred between the drop and the solid. These results can be extended to a number of other applications, including, but not limited to, freezing water droplets impacting a cold surface, as well as metal droplet-induced fouling observed in turbines and thermal spray coating systems. Similarly, one can extend this idea to other diffusion processes, such as chemical and particle transport that occur during droplet-based corrosion and fouling processes.

### EQUIVALENTS

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A manufactured article comprising a surface that is one or more of the following:
(a) a superhydrophobic surface, (b) a superoleophobic surface, and/or (c) a supermetallophobic surface,
wherein said surface comprises one or more types of macro features, said one or more types of macro features comprising one or more members selected from the following:
(i) spaced-apart discrete groups of ridges, wherein each group of ridges comprises a plurality of ridges, said ridges being angled with respect to each other and/or said ridges intersecting each other and/or two or more of said ridges terminating at a common point;
(ii) spaced-apart discrete groups of grooves, wherein each group of grooves comprises a plurality of grooves, said grooves being angled with respect to each other and/or said grooves intersecting each other and/or two or more of said grooves terminating at a common point;
(iii) a pattern of intersecting ridges, wherein said pattern comprises spaced-apart intersections of ridges;
(iv) a pattern of intersecting grooves, wherein said pattern comprises spaced-apart intersections of grooves;
(v) a pattern of ridges and grooves that intersect with each other;
(vi) spaced-apart discrete groups of features, each of said groups comprising one or more ridges and one or more grooves;
(vii) a plurality of spaced-apart hybrid ridge-groove features, each of said ridge-groove features comprising a ridge having a groove running along its length, said groove laying between the two edges of the ridge; and
(viii) a plurality of spaced-apart hybrid groove-ridge features, each of said groove-ridge features comprising a groove having a ridge running along its length, said ridge laying between the two edges of the groove.

2. The article of claim 1, wherein the macro features have a height or depth of from about 10 micrometers to about 500 micrometers, and a height of from about 20 micrometers to about 1000 micrometers.

3. The article of claim 1, wherein the macro features are spaced from about 0.1 millimeter to about 10 millimeters apart.

4. The article of claim 1, wherein the surface has a submicron roughness.

5. The article of claim 1, wherein the article is a condenser, a fabric, a solar panel, a building component, a vehicle, and/or industrial equipment.

6. The article of claim 1, wherein the surface is a superhydrophobic surface having a static contact angle with water of at least 120° and a contact angle hysteresis with water of less than 30°, irrespective of the presence of macro features.

7. The article of claim 1, wherein the surface is a superoleophobic surface having a contact angle with liquid oil of at least 120° and a contact angle hysteresis with the liquid oil of less than 30°.

8. The article of claim 7, wherein the liquid oil comprises at least one oil selected from the list comprising an alkane, a silicone oil, and a fluorocarbon.

9. The article of claim 1, wherein the surface is a supermetallophobic surface having a static contact angle with liquid metal of at least 120° and a contact angle hysteresis with the liquid metal of less than 30°.

10. The article of claim 9, wherein the liquid metal is liquid tin.

11. The article of claim 1, further comprising an impinging droplet that recoils from the surface asymmetrically, wherein the impinging droplet contacts the surface for a time period less than theoretical minimum contact time t_{c}:
$$2.2 {( \frac{ρ {R}^{3}}{γ} )}^{1 / 2} ( 1 + \frac{ϕ}{4} ) ,$$
where t_{c} is the contact time of a drop, of radius R, density ρ, and surface tension γ, bouncing on the surface with pinning fraction ϕ, wherein the impinging droplet recoils from the surface asymmetrically after contacting the surface.

12. The article of claim 11, wherein the contact time is less than 50% of the theoretical minimum contact time t_{c}.

13. The article of claim 1, wherein the surface comprises a C6 fluoropolymer.

14. The article of claim 13, wherein the C6 fluoropolymer is or comprises poly(2-(Perfluoro-3-methylbutyl)ethyl methacrylate).

15. The article of claim 13, wherein the C6 fluoropolymer is selected from the group consisting of 3,3,4,4,5,5,6,6,7,7,8,8,8-tridecafluorooctyl methacrylate; 1H, 1H, 2H, 2H-perfluorooctyl acrylate; 2-(perfluorohexyl) ethyl methacrylate; [N-methyl-perfluorohexane-1-sulfonamide]ethyl acrylate; [N-methyl-perfluorohexane-1-sulfonamide]ethyl (meth) acrylate; 2-(Perfluoro-3-methylbutyl)ethyl methacrylate; 2-[[[[2-(perfluorohexyl) ethyl]sulfonyl]methyl]-amino]ethyl]acrylate; and any combination or copolymers thereof.

16. The article of claim 1, further comprising a rare earth material.

17. The article of claim 16, wherein the rare earth material is a rare earth oxide.

18. The article of claim 16, wherein the rare earth material comprises at least one member selected from the group consisting of scandium (Sc), yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), and lutetium (Lu).

19. The article of claim 1, further comprising impinging droplets or liquid, wherein the one or members (i)-(viii) facilitate asymmetric recoil of a higher proportion of the impinging droplets or liquid from the surface per unit area of the surface.

20. The article of claim 1, where said one or more types of macro features comprise (v) the pattern of ridges and grooves that intersect with each other, comprising at least one pattern selected from the group consisting of ridges intersecting with ridges, grooves intersecting with grooves, and/or ridges intersecting with grooves.

21-26. (canceled)
